(19) United States
(12) Patent Application Publication
(10) Pub. No.: US 2026/0094872 A1
(43) Pub. Date: Apr. 2, 2026

(54) TERNARY SOLVENT ELECTROLYTES FOR HIGH VOLTAGE AND HIGH RATE LITHIUM BATTERIES

(71) Applicant: Sepion Technologies, Inc., Alameda, CA (US)

(72) Inventors: JESSICA H. GOLDEN, Alameda, CA (US); NICHOLAS JOAQUIN VAZQUEZ, Alameda, CA (US); STEVEN J. LYLE, Alameda, CA (US)

(21) Appl. No.: 19/115,034

(22) PCT Filed: Sep. 26, 2023
(86) PCT No.: PCT/US2023/075120

§ 371 Date: Mar. 25, 2025

Related U.S. Application Data
(60) Provisional application No. 63/377,310, filed on Sep. 27, 2022.

(51) Int. Cl. H01M 10/0569; H01M 10/0525; H01M 10/0567; H01M 10/0568; H01M 50/489

(52) U.S. Cl. CPC H01M 10/0569; H01M 10/0525; H01M 10/0567; H01M 10/0568; H01M 50/489; H01M 2300/004

(57) ABSTRACT

Ternary electrolyte compositions are described, having a primary solvent, a mediating solvent, a diluent, and at least one lithium salt.

### CROSS-REFERENCES TO RELATED APPLICATIONS

This application claims priority to U.S. Provisional Application No. 63/377,310, filed Sep. 27, 2022, which is incorporated herein in its entirety for all purposes.

### BACKGROUND OF THE INVENTION

Carbonate solvents demonstrate poor performance in lithium metal cells under EV-relevant cell design constraints and cell cycling protocols. High concentration and locally high concentration electrolytes have been touted in the literature as solving the problems identified in conventional battery electrolyte systems. However, these electrolytes suffer from poor rate performance. Even the best performing of these electrolytes are rapidly degraded under fast-charge conditions. As yet, no single electrolyte solvent has been identified which offers the electrochemical stability required for stable (300+ cycle), EV-relevant rate performance in a high energy density lithium metal cell with a high voltage cathode (at least 4.3 V) such as NMC.

LHCEs, which combine the kinetic stability provided by high concentration solvent-in-salt type electrolytes with improved ion transport via the incorporation of a diluent “solvent” remain limited in ionic transport by relatively low conductivities and high viscosities, and appear further to suffer from poor interfacial charge transfer which limits high rate (power) performance due to the inherent fact that in this design Li⁺ ions are bound in tight solvation shells. The complete non-solvent behavior of the electrochemically stable diluent provides an ionically insulating barrier to charge transport and charge transfer processes. The addition of a third, mediating solvent can overcome the barrier to Li⁺ desolvation, improving dynamic networking within the electrolyte, and thereby improving conductivity and rate performance, leading to more stable, longer-lasting high voltage, high energy density lithium metal battery electrochemical cells. Surprisingly, the present invention meets this and other needs.

### BRIEF SUMMARY OF THE INVENTION

In one embodiment, the present invention provides an electrolyte composition comprising: a primary solvent; a mediating solvent; a diluent; and a first lithium salt, wherein each of the primary solvent, mediating solvent, and diluent are different.

In another embodiment, the present invention provides an electrochemical device comprising: an anode; a cathode; a separator between the anode and cathode; and an electrolyte composition of the present invention.

### BRIEF DESCRIPTION OF THE DRAWINGS

FIG. 1 shows simulated Li+ coordination complexes of example primary solvents, mediating solvents, and diluents.

FIG. 2 shows the discharge capacity vs cycle life plots of lithium metal battery cells are shown for cells built using three different electrolytes. Curves represent the mean discharge capacity of a set of lithium metal battery cells (n=3-4). Cells were cycled from 3.0 V to 4.3 V using current densities of 3.8 mAh/cm² charge and 1.9 mAh/cm² discharge. Two ternary blend electrolytes (Electrolyte 1-4 and Electrolyte 2-1) are contrasted with a locally high concentrated electrolyte (Electrolyte E5) formulated according to published experimental details (Battery 500—Nat. Energy, 6, 2021, 723-732.).

FIG. 3 shows the discharge capacity vs cycle life plots of lithium metal battery cells are shown for cells built using five different electrolytes. Curves represent the mean discharge capacity of a set of lithium metal battery cells (n=4). Cells were cycled from 3.0 V to 4.3 V using current densities of 1.27 mAh/cm² charge and 1.27 mAh/cm² discharge. Four ternary blend electrolytes (Electrolyte 1-4, Electrolyte 2-1, Electrolyte 1-2, and Electrolyte 1-3) are contrasted with a locally high concentrated electrolyte (Electrolyte E5) formulated according to published experimental details (Battery 500—Nat. Energy, 6, 2021, 723-732.).

FIG. 4 shows the discharge capacity vs cycle life plots of lithium metal battery cells are shown for cells built using two different ternary blend electrolytes. Curves represent the mean discharge capacity of a set of lithium metal battery cells (n=3). Cells were cycled from 3.0 V to 4.2 V using current densities of 0.76 mAh/cm² charge and 3.8 mAh/cm² discharge.

FIG. 5 shows the discharge capacity vs cycle life plots of lithium metal battery cells are shown for cells built using six different ternary blend electrolytes. Curves represent the mean discharge capacity of a set of lithium metal battery cells (n=4). Cells were cycled from 3.0 V to 4.3 V using current densities of 0.76 mAh/cm² charge and 3.8 mAh/cm² discharge.

FIG. 6. shows the discharge capacity vs cycle life plots of lithium metal battery cells comprising a PIM-13 coated separator are shown for cells built using three different electrolytes. Curves represent the mean discharge capacity of a set of lithium metal battery cells (n=3-4). Cells were cycled from 3.0 V to 4.3 V using current densities of 1.27 mAh/cm² charge and 1.27 mAh/cm² discharge. Two ternary blend electrolytes (Electrolyte 1-4 and Electrolyte 2-1) are contrasted with a carbonate electrolyte (Electrolyte E4).

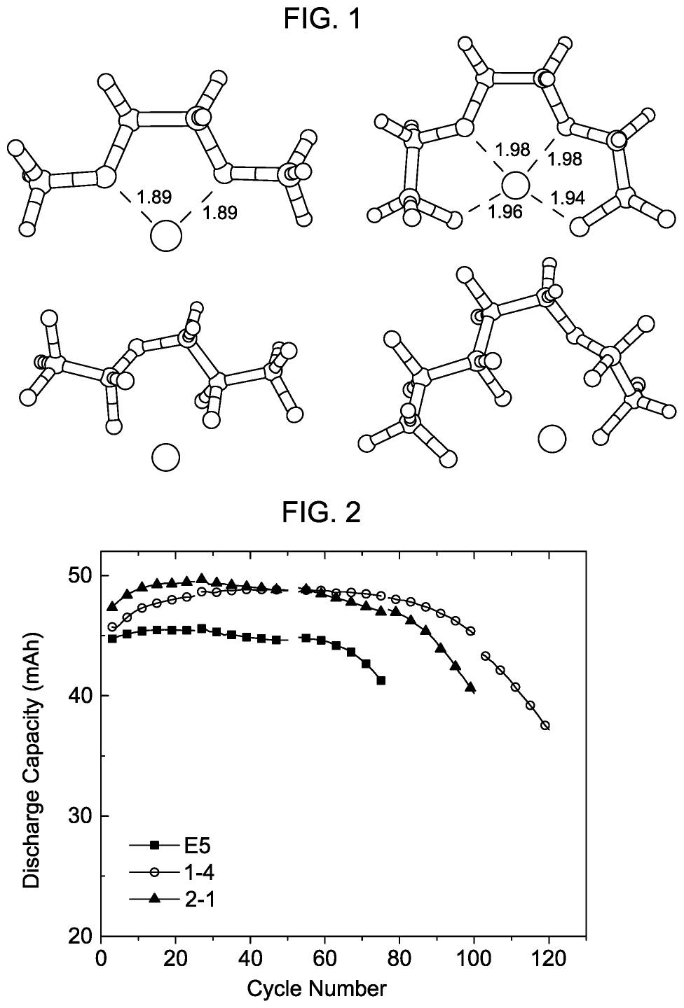

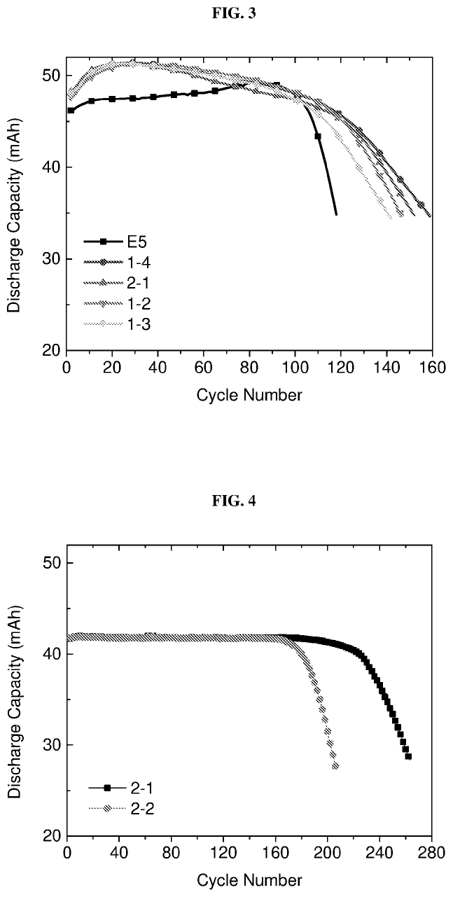

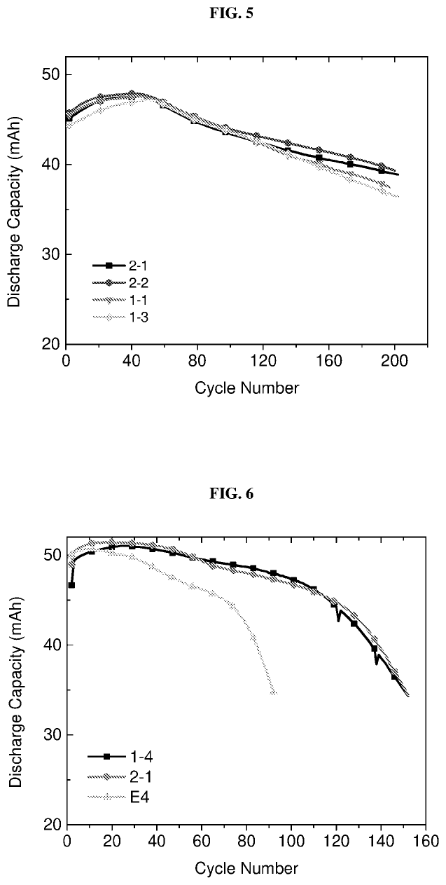

### DETAILED DESCRIPTION OF THE INVENTION

### I. General

The present invention provides ternary electrolyte compositions having at least one lithium salt and three different liquid components including a primary solvent having a high coordination strength with the lithium ions, a mediating solvent having a moderate to weak coordination strength with the lithium ions, and a diluent having a low coordination strength with the lithium ions. The ternary electrolyte compositions can also include a second lithium salt, and an additive.

### II. Definitions

“Electrolyte” or “electrolyte composition” refers to a solution of the electrochemical cell that includes ions, such as metal ions and protons as well as anions, that provides ionic communication between the positive and negative electrodes.

“Electrolyte Solvent” refers to the molecules solvating ions in the liquid electrolyte, such as small organic molecules, that enable diffusion of ions in the electrolyte. The electrolyte solvent may also be an ionic liquid or a gas at standard temperature and pressure.

“Primary solvent” refers to a solvent having a high Li⁺ coordination strength capable of dissolving a lithium salt, and a relatively low molecular weight.

“Mediating solvent” refers to a solvent having low to moderate Li⁺ coordination strength and is substantially miscible with both the primary solvent and the diluent.

“Diluent” refers to a non-solvent having a low Li⁺ coordination strength that allows the primary solvent to occupy the first solvation shell of Li⁺. Lithium salts of the invention are substantially insoluble in the diluent. The diluent is substantially miscible with the mediating solvent. The diluent can also reduce the viscosity of the electrolyte composition.

“Lithium salt” refers to an inorganic salt having a lithium ion, Li⁺, and an anionic counterion.

“Ether” refers to a chemical compound of the formula R¹—O—R², where R¹ and R² can be the same or different and are typically an alkyl, haloalkyl, cycloalkyl, heterocycloalkyl, aryl or heteroaryl. R¹ and R² can also be combined to form a cyclic ether. Representative ethers include, but are not limited to, dimethyl ether, diethyl ether, oxirane, tetrahydrofuran, pyran, and 1,4-dioxane. A fluorinated ether is formed when one of R¹ and R² is fluorinated.

“Glyme” refers to a chemical compound having two ether groups, such as represented by the formula R³—O-alkylene-O—R⁴, where R³ and R⁴ can be the same or different and are typically an alkyl, haloalkyl, cycloalkyl, heterocycloalkyl, aryl or heteroaryl. Representative glymes include, but are not limited to, monoglyme (1,2-dimeothoxyethane), diglyme (diethylene glycol dimethyl ether), triglyme (triethylene glycol dimethyl ether). A fluorinated glyme is formed when one of R³ and R⁴ is fluorinated.

“Carbonate” refers to a chemical compound represented by the formula R⁵—O—C(O)—O—R⁶, where R⁵ and R⁶ can be the same or different and are typically an alkyl, haloalkyl, cycloalkyl, heterocycloalkyl, aryl or heteroaryl, or can be combined to form a cyclic carbonate. Representative carbonates include, but are not limited to, ethylene carbonate or fluoroethylene carbonate (FEC). A fluorinated carbonate is formed when one of R⁵ and R⁶ is fluorinated.

“Alkyl” refers to a straight or branched, saturated, aliphatic radical having the number of carbon atoms indicated. Alkyl can include any number of carbons, such as C₁₋₂, C₁₋₃, C₁₋₄, C₁₋₅, C₁₋₆, C₁₋₇, C₁₋₈, C₁₋₉, C₁₋₁₀, C₂₋₃, C₂₋₄, C₂₋₅, C₂₋₆, C₃₋₄, C₃₋₅, C₃₋₆, C₄₋₅, C₄₋₆ and C₅₋₆. For example, C₁₋₆ alkyl includes, but is not limited to, methyl, ethyl, propyl, isopropyl, butyl, isobutyl, sec-butyl, tert-butyl, pentyl, isopentyl, hexyl, etc. Alkyl can also refer to alkyl groups having up to 20 carbons atoms, such as, but not limited to heptyl, octyl, nonyl, decyl, etc. Alkyl groups can be substituted or unsubstituted.

“Alkylene” refers to a straight or branched, saturated, aliphatic radical having the number of carbon atoms indicated, and linking at least two other groups, i.e., a divalent hydrocarbon radical. The two moieties linked to the alkylene can be linked to the same atom or different atoms of the alkylene group. For instance, a straight chain alkylene can be the bivalent radical of —(CH₂)ₙ—, where n is 1, 2, 3, 4, 5 or 6. Representative alkylene groups include, but are not limited to, methylene, ethylene, propylene, isopropylene, butylene, isobutylene, sec-butylene, pentylene and hexylene. Alkylene groups can be substituted or unsubstituted.

“Alkenyl” refers to a straight chain or branched hydrocarbon having at least 2 carbon atoms and at least one double bond. Alkenyl can include any number of carbons, such as C₂, C₂₋₃, C₂₋₄, C₂₋₅, C₂₋₆, C₂₋₇, C₂₋₈, C₂₋₉, C₂₋₁₀, C₃, C₃₋₄, C₃₋₅, C₃₋₆, C₄, C₄₋₅, C₄₋₆, C₅, C₅₋₆, and C₆. Alkenyl groups can have any suitable number of double bonds, including, but not limited to, 1, 2, 3, 4, 5 or more. Examples of alkenyl groups include, but are not limited to, vinyl (ethenyl), propenyl, isopropenyl, 1-butenyl, 2-butenyl, isobutenyl, butadienyl, 1-pentenyl, 2-pentenyl, isopentenyl, 1,3-pentadienyl, 1,4-pentadienyl, 1-hexenyl, 2-hexenyl, 3-hexenyl, 1,3-hexadienyl, 1,4-hexadienyl, 1,5-hexadienyl, 2,4-hexadienyl, or 1,3,5-hexatrienyl. Alkenyl groups can be substituted or unsubstituted.

“Alkynyl” refers to either a straight chain or branched hydrocarbon having at least 2 carbon atoms and at least one triple bond. Alkynyl can include any number of carbons, such as C₂, C₂₋₃, C₂₋₄, C₂₋₅, C₂₋₆, C₂₋₇, C₂₋₈, C₂₋₉, C₂₋₁₀, C₃, C₃₋₄, C₃₋₅, C₃₋₆, C₄, C₄₋₅, C₄₋₆, C₅, C₅₋₆, and C₆. Examples of alkynyl groups include, but are not limited to, acetylenyl, propynyl, 1-butynyl, 2-butynyl, butadiynyl, 1-pentynyl, 2-pentynyl, isopentynyl, 1,3-pentadiynyl, 1,4-pentadiynyl, 1-hexynyl, 2-hexynyl, 3-hexynyl, 1,3-hexadiynyl, 1,4-hexadiynyl, 1,5-hexadiynyl, 2,4-hexadiynyl, or 1,3,5-hexatriynyl. Alkynyl groups can be substituted or unsubstituted.

“Halogen” refers to fluorine, chlorine, bromine and iodine.

“Haloalkyl” refers to alkyl, as defined above, where some or all of the hydrogen atoms are replaced with halogen atoms. As for alkyl group, haloalkyl groups can have any suitable number of carbon atoms, such as C₁₋₆. For example, haloalkyl includes trifluoromethyl, fluoromethyl, etc. In some instances, the term “perfluoro” can be used to define a compound or radical where all the hydrogens are replaced with fluorine. For example, perfluoromethyl refers to 1,1,1-trifluoromethyl.

“Haloalkylene” refers to alkylene, as defined above, where some or all of the hydrogen atoms are replaced with halogen atoms. As for alkyl group, haloalkylene groups can have any suitable number of carbon atoms, such as C₂₋₆, C₂₋₄, C₃₋₆, or C₄₋₆. For example, haloalkylene includes 2,2,3,3-tetrafluorobutylene, etc.

“Cycloalkyl” refers to a saturated or partially unsaturated, monocyclic, fused bicyclic or bridged polycyclic ring assembly containing from 3 to 12 ring atoms, or the number of atoms indicated. Cycloalkyl can include any number of carbons, such as C₃₋₆, C₄₋₆, C₅₋₆, C₃₋₈, C₄₋₈, C₅₋₈, C₆₋₈, C₃₋₉, C₃₋₁₀, C₃₋₁₁, and C₃₋₁₂. Saturated monocyclic cycloalkyl rings include, for example, cyclopropyl, cyclobutyl, cyclopentyl, cyclohexyl, and cyclooctyl. Saturated bicyclic and polycyclic cycloalkyl rings include, for example, norbornane, [2.2.2] bicyclooctane, decahydronaphthalene and adamantane. Cycloalkyl groups can also be partially unsaturated, having one or more double or triple bonds in the ring. Representative cycloalkyl groups that are partially unsaturated include, but are not limited to, cyclobutene, cyclopentene, cyclohexene, cyclohexadiene (1,3- and 1,4-isomers), cycloheptene, cycloheptadiene, cyclooctene, cyclooctadiene (1,3-, 1,4- and 1,5-isomers), norbornene, and norbornadiene. When cycloalkyl is a saturated monocyclic C₃₋₈ cycloalkyl, exemplary groups include, but are not limited to cyclopropyl, cyclobutyl, cyclopentyl, cyclohexyl, cycloheptyl and cyclooctyl. When cycloalkyl is a saturated monocyclic C₃₋₆ cycloalkyl, exemplary groups include, but are not limited to cyclopropyl, cyclobutyl, cyclopentyl, and cyclohexyl. Cycloalkyl groups can be substituted or unsubstituted.

“Cycloalkylene” refers to a cycloalkyl group having the number of carbon atoms indicated, and linking at least two other groups, i.e., a divalent radical. The two moieties linked to the cycloalkylene can be linked to the same atom or different atoms of the cycloalkylene group. Examples of cycloalkylene rings include cyclopropylene, cyclobutylene, cyclopentylene and cyclohexylene, among others. Cycloalkylene groups can be linked 1,1, 1,2, 1,3, or 1,4. The cyclohexylene ring, for example, can adopt a number of conformations, including the boat and chair conformations. The chair conformation of cyclohexylene can have substituents in an axial or equatorial orientation. The divalent nature of the cycloalkylenes results in cis and trans formations where cis refers to both substituents being on the same side (top or bottom) of the cycloalkylene ring, and where trans refers to the substituents being on opposite sides of the cycloalkylene ring. For example, cis-1,2- and cis-1,4-cyclohexylene can have one substituent in the axial orientation and the other substituent in the equatorial orientation, while trans-1,2- and trans-1,4-cyclohexylene have both substituents in the axial or equatorial orientation. cis-1,3-cyclohexylene have both substituents in the axial or equatorial orientation, and trans-1,3-cyclohexylene can have one substituent in the axial orientation and the other substituent in the equatorial orientation. Cycloalkylene groups can be substituted or unsubstituted.

“Heterocycloalkyl” refers to a saturated ring system having from 3 to 12 ring members and from 1 to 4 heteroatoms of N, O and S. Additional heteroatoms can also be useful, including, but not limited to, B, Al, Si and P. The heteroatoms can also be oxidized, such as, but not limited to, —S(O)— and —S(O)₂—. Heterocycloalkyl groups can include any number of ring atoms, such as, 3 to 6, 4 to 6, 5 to 6, 3 to 8, 4 to 8, 5 to 8, 6 to 8, 3 to 9, 3 to 10, 3 to 11, or 3 to 12 ring members. Any suitable number of heteroatoms can be included in the heterocycloalkyl groups, such as 1, 2, 3, or 4, or 1 to 2, 1 to 3, 1 to 4, 2 to 3, 2 to 4, or 3 to 4. The heterocycloalkyl group can include groups such as aziridine, azetidine, pyrrolidine, piperidine, azepane, azocane, quinuclidine, pyrazolidine, imidazolidine, piperazine (1,2-, 1,3- and 1,4-isomers), oxirane, oxetane, tetrahydrofuran, oxane (tetrahydropyran), oxepane, thiirane, thietane, thiolane (tetrahydrothiophene), thiane (tetrahydrothiopyran), oxazolidine, isoxazolidine, thiazolidine, isothiazolidine, dioxolane, dithiolane, morpholine, thiomorpholine, dioxane, or dithiane. The heterocycloalkyl groups can also be fused to aromatic or non-aromatic ring systems to form members including, but not limited to, indoline. Heterocycloalkyl groups can be unsubstituted or substituted. For example, heterocycloalkyl groups can be substituted with C₁₋₆ alkyl or oxo (═O), among many others.

The heterocycloalkyl groups can be linked via any position on the ring. For example, aziridine can be 1- or 2-aziridine, azetidine can be 1- or 2-azetidine, pyrrolidine can be 1-, 2- or 3-pyrrolidine, piperidine can be 1-, 2-, 3- or 4-piperidine, pyrazolidine can be 1-, 2-, 3, or 4-pyrazolidine, imidazolidine can be 1-, 2-, 3- or 4-imidazolidine, piperazine can be 1-, 2-, 3- or 4-piperazine, tetrahydrofuran can be 1- or 2-tetrahydrofuran, oxazolidine can be 2-, 3, 4- or 5-oxazolidine, isoxazolidine can be 2-, 3, 4- or 5-isoxazolidine, thiazolidine can be 2-, 3, 4- or 5-thiazolidine, isothiazolidine can be 2-, 3, 4- or 5-isothiazolidine, and morpholine can be 2-, 3- or 4-morpholine.

When heterocycloalkyl includes 3 to 8 ring members and 1 to 3 heteroatoms, representative members include, but are not limited to, pyrrolidine, piperidine, tetrahydrofuran, oxane, tetrahydrothiophene, thiane, pyrazolidine, imidazolidine, piperazine, oxazolidine, isoxzoalidine, thiazolidine, isothiazolidine, morpholine, thiomorpholine, dioxane and dithiane. Heterocycloalkyl can also form a ring having 5 to 6 ring members and 1 to 2 heteroatoms, with representative members including, but not limited to, pyrrolidine, piperidine, tetrahydrofuran, tetrahydrothiophene, pyrazolidine, imidazolidine, piperazine, oxazolidine, isoxazolidine, thiazolidine, isothiazolidine, and morpholine.

“Aryl” refers to an aromatic ring system having any suitable number of ring atoms and any suitable number of rings. Aryl groups can include any suitable number of ring atoms, such as, 6, 7, 8, 9, 10, 11, 12, 13, 14, 15 or 16 ring atoms, as well as from 6 to 10, 6 to 12, or 6 to 14 ring members. Aryl groups can be monocyclic, fused to form bicyclic or tricyclic groups, or linked by a bond to form a biaryl group. Representative aryl groups include phenyl, naphthyl and biphenyl. Other aryl groups include benzyl, having a methylene linking group. Some aryl groups have from 6 to 12 ring members, such as phenyl, naphthyl or biphenyl. Other aryl groups have from 6 to 10 ring members, such as phenyl or naphthyl. Some other aryl groups have 6 ring members, such as phenyl. Aryl groups can be substituted or unsubstituted.

“Heteroaryl” refers to a monocyclic or fused bicyclic or tricyclic aromatic ring assembly containing 5 to 16 ring atoms, where from 1 to 5 of the ring atoms are a heteroatom such as N, O or S. Additional heteroatoms can also be useful, including, but not limited to, B, Al, Si and P. The heteroatoms can also be oxidized, such as, but not limited to, —S(O)— and —S(O)₂—. Heteroaryl groups can include any number of ring atoms, such as, 5 to 6, 5 to 8, 6 to 8, 5 to 9, 5 to 10, 5 to 11, or 5 to 12 ring members. Any suitable number of heteroatoms can be included in the heteroaryl groups, such as 1, 2, 3, 4, or 5, or 1 to 2, 1 to 3, 1 to 4, 1 to 5, 2 to 3, 2 to 4, 2 to 5, 3 to 4, or 3 to 5. Heteroaryl groups can have from 5 to 8 ring members and from 1 to 4 heteroatoms, or from 5 to 8 ring members and from 1 to 3 heteroatoms, or from 5 to 6 ring members and from 1 to 4 heteroatoms, or from 5 to 6 ring members and from 1 to 3 heteroatoms. The heteroaryl group can include groups such as pyrrole, pyridine, imidazole, pyrazole, triazole, tetrazole, pyrazine, pyrimidine, pyridazine, triazine (1,2,3-, 1,2,4- and 1,3,5-isomers), thiophene, furan, thiazole, isothiazole, oxazole, and isoxazole. The heteroaryl groups can also be fused to aromatic ring systems, such as a phenyl ring, to form members including, but not limited to, benzopyrroles such as indole and isoindole, benzopyridines such as quinoline and isoquinoline, benzopyrazine (quinoxaline), benzopyrimidine (quinazoline), benzopyridazines such as phthalazine and cinnoline, benzothiophene, and benzofuran. Other heteroaryl groups include heteroaryl rings linked by a bond, such as bipyridine. Heteroaryl groups can be substituted or unsubstituted.

The heteroaryl groups can be linked via any position on the ring. For example, pyrrole includes 1-, 2- and 3-pyrrole, pyridine includes 2-, 3- and 4-pyridine, imidazole includes 1-, 2-, 4- and 5-imidazole, pyrazole includes 1-, 3-, 4- and 5-pyrazole, triazole includes 1-, 4- and 5-triazole, tetrazole includes 1- and 5-tetrazole, pyrimidine includes 2-, 4-, 5- and 6-pyrimidine, pyridazine includes 3- and 4-pyridazine, 1,2,3-triazine includes 4- and 5-triazine, 1,2,4-triazine includes 3-, 5- and 6-triazine, 1,3,5-triazine includes 2-triazine, thiophene includes 2- and 3-thiophene, furan includes 2- and 3-furan, thiazole includes 2-, 4- and 5-thiazole, isothiazole includes 3-, 4- and 5-isothiazole, oxazole includes 2-, 4- and 5-oxazole, isoxazole includes 3-, 4- and 5-isoxazole, indole includes 1-, 2- and 3-indole, isoindole includes 1- and 2-isoindole, quinoline includes 2-, 3- and 4-quinoline, isoquinoline includes 1-, 3- and 4-isoquinoline, quinazoline includes 2- and 4-quinoazoline, cinnoline includes 3- and 4-cinnoline, benzothiophene includes 2- and 3-benzothiophene, and benzofuran includes 2- and 3-benzofuran.

Some heteroaryl groups include those having from 5 to 10 ring members and from 1 to 3 ring atoms including N, O or S, such as pyrrole, pyridine, imidazole, pyrazole, triazole, pyrazine, pyrimidine, pyridazine, triazine (1,2,3-, 1,2,4- and 1,3,5-isomers), thiophene, furan, thiazole, isothiazole, oxazole, isoxazole, indole, isoindole, quinoline, isoquinoline, quinoxaline, quinazoline, phthalazine, cinnoline, benzothiophene, and benzofuran. Other heteroaryl groups include those having from 5 to 8 ring members and from 1 to 3 heteroatoms, such as pyrrole, pyridine, imidazole, pyrazole, triazole, pyrazine, pyrimidine, pyridazine, triazine (1,2,3-, 1,2,4- and 1,3,5-isomers), thiophene, furan, thiazole, isothiazole, oxazole, and isoxazole. Some other heteroaryl groups include those having from 9 to 12 ring members and from 1 to 3 heteroatoms, such as indole, isoindole, quinoline, isoquinoline, quinoxaline, quinazoline, phthalazine, cinnoline, benzothiophene, benzofuran and bipyridine. Still other heteroaryl groups include those having from 5 to 6 ring members and from 1 to 2 ring atoms including N, O or S, such as pyrrole, pyridine, imidazole, pyrazole, pyrazine, pyrimidine, pyridazine, thiophene, furan, thiazole, isothiazole, oxazole, and isoxazole.

Some heteroaryl groups include from 5 to 10 ring members and only nitrogen heteroatoms, such as pyrrole, pyridine, imidazole, pyrazole, triazole, pyrazine, pyrimidine, pyridazine, triazine (1,2,3-, 1,2,4- and 1,3,5-isomers), indole, isoindole, quinoline, isoquinoline, quinoxaline, quinazoline, phthalazine, and cinnoline. Other heteroaryl groups include from 5 to 10 ring members and only oxygen heteroatoms, such as furan and benzofuran. Some other heteroaryl groups include from 5 to 10 ring members and only sulfur heteroatoms, such as thiophene and benzothiophene. Still other heteroaryl groups include from 5 to 10 ring members and at least two heteroatoms, such as imidazole, pyrazole, triazole, pyrazine, pyrimidine, pyridazine, triazine (1,2,3-, 1,2,4- and 1,3,5-isomers), thiazole, isothiazole, oxazole, isoxazole, quinoxaline, quinazoline, phthalazine, and cinnoline.

“Additive” refers to a component comprising less than 10 mol % of the electrolyte, wherein the additive is added to the electrolyte to induce a mechanistic effect which is unique from that of either a solvent or a salt comprising a working ion, for example an additive may be selected to preferentially decompose at an electrode surface providing a preferred solid electrolyte interphase, to bind or network working ions or solvation clusters, to bind or network anions to increase transference number, to reduce viscosity, or to increase conductivity.

“Conductivity” or “specific conductance” refers to the electrical conductivity of a an electrolyte solution, as measured in Siemens per meter (S/m or mS/cm).

“Dynamic viscosity” refers to the material property which relates to viscous stresses in a material in response to a strain rate such a shear stress, as measured in units of centipoise (cP) or equivalently millipascal-seconds (mPa·s).

“Electrochemical device” refers to a device wherein an electric current is produced by a chemical reaction, wherein electrons are transferred directly between molecules and/or atoms in oxidation-reduction reactions.

“Electrode” refers to an electrically conductive material in a circuit that is in contact with a nonmetallic part of the circuit, such as the electrolyte. The electrode can be a positive electrode or cathode, the electrode where reduction occurs. The electrode can be a negative electrode or anode, the electrode where oxidation occurs.

“Separator” refers to an electrically insulating membrane between the positive and negative electrodes to prevent electrical shorts, i.e., provides electronic isolation. The separator also allows the ions to move between the positive and anode electrodes. The separator can include any suitable polymeric or inorganic material that is electrically insulating. The separator can include several layers including one or more membrane layers, and a porous support material for the membrane layers.

“First polymer layer” refers to a layer of the separator that is permeable to a first species of the electrolyte while substantially impermeable to liquid electrolyte. The membrane layer can be of any suitable material that can provide the selective permeability, such as composites of microporous polymers and inorganic materials. “Substantially impermeable” refers to less than 10% of the electrolyte solvent passing through the membrane layer, or less than 1%, or less than 0.1%, or less than 0.01%, or less than 0.001% of the liquid electrolyte passing through the membrane layer.

“Polymer of intrinsic microporosity” refers to a polymer that exhibits microporosity due to the shape and rigidity of the molecular structure of the repeat units within the polymer, where the repeat units may align relative to one another such that spaces or openings are generated along the polymer chain. Additionally or alternatively, the repeat units may align in an aggregate of the polymer in a way that frustrates packing of the polymer molecules in the aggregate such that spaces or openings are generated between different polymer molecules and/or between segments of the same polymer molecule. These spaces within the aggregated polymer may, at least in part, provide the microporosity to such a polymer. Due to the inclusion of the micropores, some polymers of intrinsic microporosity may exhibit high surface areas, such as a surface area selected from the range of 300 m² g⁻¹ to 1500 m² g⁻¹. Example polymers of intrinsic microporosity include, but are not limited to, those described in U.S. Application Publication Nos. 2017/0346104 and 2018/0085744, U.S. Pat. Nos. 7,690,514, and 8,056,732, and PCT Publication Nos. WO 2005/012397, and WO 2005/113121, each of which is incorporated herein by reference.

“Oxide” refers to a chemical compound having an oxygen, such as metal oxides or molecular oxides.

“Pore size” or “pore diameter” refers to the average diameter of interstitial space not occupied by the pore forming material. This may include, but is not limited to, the space remaining between polymer chains due to inefficient packing, the space remaining between organic linkers and metal ions in a metal-organic framework, the space between layers and within the holes of stacked 2D material, and the space left in an amorphous or semi-crystalline carbon due to unaligned covalent bonding. The pore size may also change once wetted with electrolyte or it may stay the same.

“Surface area” refers to the surface area of a porous material as measured by a variety of methods, such as nitrogen adsorption BET.

“Microporous polymer” refers to an amorphous glassy polymer having interconnected pores with an average diameter of less than 10 nm, or less than 5, 4, 3, 2, or less than 1 nm.

“Microporosity” refer to a layer of the membrane comprising pores of less than or equal to 2 nm in size.

“Intrinsic microporosity” is used herein to mean the polymer provides a continuous network of interconnected intermolecular voids (suitably of less than or equal to 2 nm in size), which forms as a direct consequence of the shape and rigidity of at least a proportion of the component monomers of the polymer. As will be appreciated by a person skilled in the art, intrinsic microporosity arises due to the structure of the monomers used to form the polymer and, as the term suggests, it is an intrinsic property of a polymer formed from such monomers.

It is understood that the network polymers disclosed herein have a certain property (i.e. intrinsic microporosity). Disclosed herein are certain structural requirements in the monomers used for giving a polymer performing the disclosed function, and it is understood that there are a variety of structures that can perform the same function that are related to the disclosed monomer structures, and that these structures will typically achieve the same result.

“Metal” refers to elements of the periodic table that are metallic and that can be neutral, or negatively or positively charged as a result of having more or fewer electrons in the valence shell than is present for the neutral metallic element. Metals useful in the present invention include the alkali metals, alkali earth metals, transition metals and post-transition metals. Alkali metals include Li, Na, K, Rb and Cs. Alkaline earth metals include Be, Mg, Ca, Sr and Ba. Transition metals include Sc, Ti, V, Cr, Mn, Fe, Co, Ni, Cu, Zn, Y, Zr, Nb, Mo, Tc, Ru, Rh, Pd, Ag, Cd, La, Hf, Ta, W, Re, Os, Ir, Pt, Au, Hg and Ac. Post-transition metals include Al, Ga, In, TI, Ge, Sn, Pb, Sb, Bi, and Po. Rare earth metals include Sc, Y, La, Ce, Pr, Nd, Sm, Eu, Gd, Tb, Dy, Ho, Er, Tm, Yb and Lu. One of skill in the art will appreciate that the metals described above can each adopt several different oxidation states, all of which are useful in the present invention. In some instances, the most stable oxidation state is formed, but other oxidation states are useful in the present invention.

“Porous support” refers to any suitable material that is capable of supporting the membrane layer of the present invention, and is permeable to the electrolyte.

“Laminated” refers to the deposition of one layer on another, such as the microporous polymer layer or first polymer layer onto the porous support.

“Mol %” refers to the mole percentage of a component based on the total number of moles in the composition.

### III. Ternary Electrolytes

The electrolyte compositions of the present invention include a primary solvent, a mediating solvent, a diluent, and a first lithium salt, wherein each of the primary solvent, mediating solvent, and diluent are different. The solvents and components of the electrolyte compositions of the present invention interact synergistically in the electrolyte to improve the dynamic networking within the electrolyte when the battery is in use, and generally improve conductivity and overall battery performance, leading to more stable, long-lasting high voltage, high density energy. Without wishing to be bound by theory, it is believed that the combination of the three distinct solvents and lithium salts in the electrolytes of the present invention preserve the lithium salt-primary solvent clusters in the formulated electrolyte due to the selected Li+ coordination strength of the three distinct solvents, and lead to a unique solvation structure of the lithium salts in the electrolyte.

The solvents of the electrolyte compositions of the present invention are preferably miscible to avoid phase separation and form clear uniform electrolyte compositions. The primary solvent, mediating solvent, and diluent in any given electrolyte composition may be characterized by having different Li⁺ coordination strengths such the primary solvent has the strongest Li⁺ coordination strength, the diluent has the weakest Li⁺ coordination strength, and the mediating solvent has a Li⁺ coordination strength in between that of the primary solvent and the diluent. Accordingly, one compound could be classified as a mediating solvent in one electrolyte composition, but classified as a diluent in another electrolyte composition.

In some embodiments, the primary solvent, the mediating solvent and the diluent each have different Li⁺ coordination strengths. In some embodiments, the Li⁺ coordination strength of the primary solvent Ec_{(P)} is greater than the Li⁺ coordination strength of the mediating solvent Ec_{(M)}, and the Li⁺ coordination strength of the mediating solvent Ec_{(M)} is greater than that the Li⁺ coordination strength of the diluent Ec_{(D)}:

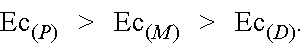

In some embodiments, the present invention provides an electrolyte composition comprising: a primary solvent; a mediating solvent; a diluent; and a first lithium salt, wherein each of the primary solvent, mediating solvent, and diluent are different.

### Primary Solvent

The primary solvent useful in the electrolyte compositions of the present invention has a high Li⁺ coordination strength and a relatively low molecular weight. Representative primary solvents include, but are not limited to, an ether, a glyme, a diglyme, a cyclic ether, and combinations thereof.

An ether of the present invention refers to compounds of the formula:

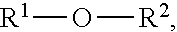

wherein R¹ and R² are each independently C₁₋₆ alkyl, C₁₋₆ haloalkyl, C₃₋₈ cycloalkyl, a heterocycloalkyl having 3 to 8 ring members and 1 to 3 heteroatoms each independently N, O or S, C₆₋₁₂ aryl, or a heteroaryl having 5 to 8 ring members and 1 to 3 heteroatoms each independently N, O or S. Alternatively, R¹ and R² can be combined to form a cyclic ether, i.e., a heterocycloalkyl having 3 to 8 ring members and 0 to 3 additional heteroatoms each independently O. Representative ethers include, but are not limited to, dimethyl ether, diethyl ether, oxirane, tetrahydrofuran, pyran, and 1,4-dioxane. A fluorinated ether can be formed when one of R¹ and R² is C₁₋₆ haloalkyl.

A glyme of the present invention refers to compounds of the formula:

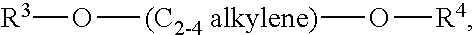

wherein R³ and R⁴ are each independently C₁₋₆ alkyl, C₁₋₆ haloalkyl, C₃₋₈ cycloalkyl, a heterocycloalkyl having 3 to 8 ring members and 1 to 3 heteroatoms each independently N, O or S, C₆₋₁₂ aryl, or a heteroaryl having 5 to 8 ring members and 1 to 3 heteroatoms each independently N, O or S; and the alkylene is substituted with 0 to 12 fluoro groups. Representative glymes include, but are not limited to, monoglyme (1,2-dimethoxy ethane), 1,2-diethoxy ethane, diglyme (diethylene glycol dimethyl ether), triglyme (triethylene glycol dimethyl ether). A fluorinated glyme is formed when one of R³ and R⁴ is C₁₋₆ haloalkyl, or the C₂₋₆ alkylene is substituted with one or more fluoro groups.

A diglyme of the present invention refers to compounds of the formula:

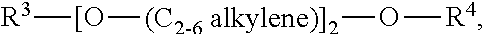

wherein R³ and R⁴ are each independently C₁₋₆ alkyl, C₁₋₆ haloalkyl, C₃₋₈ cycloalkyl, a heterocycloalkyl having 3 to 8 ring members and 1 to 3 heteroatoms each independently N, O or S, C₆₋₁₂ aryl, or a heteroaryl having 5 to 8 ring members and 1 to 3 heteroatoms each independently N, O or S; and the alkylene is substituted with 0 to 12 fluoro groups. Representative diglymes include, but are not limited to, bis(2-methoxyethyl) ether. A fluorinated diglyme is formed when one of R³ and R⁴ is C₁₋₆ haloalkyl. In some embodiments, each diglyme has the formula:

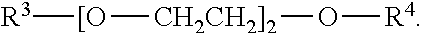

In some embodiments, the electrolyte composition is the electrolyte composition wherein the primary solvent comprises an ether, a glyme, a cyclic ether, or combinations thereof. The primary solvent can have a calculated Li⁺ coordination energy of less than −30, or less than −35, −40, −45, or less than −50.

In some embodiments, the electrolyte composition is the electrolyte composition wherein the primary solvent has the formula of

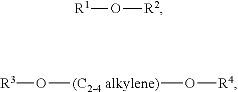

or combinations thereof, wherein
R¹ and R² are each independently C₁₋₃ alkyl;
alternatively R¹ and R² can be combined to form a heterocycloalkyl having 5 to 6 ring members and 0 to 2 additional heteroatoms each independently O; and
R³ and R⁴ are each independently C₁₋₃ alkyl.

In some embodiments, the electrolyte composition is the electrolyte composition wherein the primary solvent comprises diethylether, 1,2-dimethoxyethane, 1,2-diethoxyethane, 1,3-dioxolane, 1,4-dioxane, 1,3-dioxane, or combinations thereof. In some embodiments, the electrolyte composition is the electrolyte composition wherein the primary solvent comprises diethylether, 1,2-dimethoxyethane, 1,2-diethoxyethane, or combinations thereof. In some embodiments, the electrolyte composition is the electrolyte composition wherein the primary solvent comprises diethylether, 1,2-dimethoxyethane, 1,2-diethoxyethane, or combinations thereof. In some embodiments, the electrolyte composition is the electrolyte composition wherein the primary solvent comprises 1,2-dimethoxyethane. In some embodiments, the electrolyte composition is the electrolyte composition wherein the primary solvent comprises 1,2-diethoxyethane.

The primary solvent can be present in the electrolyte composition in any suitable amount. For example, the primary solvent can be present in the electrolyte composition in an amount of from 10 to 90 mol %, from 10 to 80 mol %, from 10 to 70 mol %, from 20 to 70 mol %, from 30 to 60 mol %, from 35 to 55 mol %, from 40 to 50 mol %, from 45 to 50 mol %, from 35 to 45 mol %, or from 45 to 55 mol %. Representative amounts of the primary solvent in the electrolyte composition include, but are not limited to, about 35 mol %, or about 36, 37, 38, 39, 40, 41, 42, 43, 44, 45, 46, 47, 48, 49, 50, 51, 52, 53, 54, or about 55 mol %.

In some embodiments, the electrolyte composition is the electrolyte composition wherein the primary solvent is present in the electrolyte composition in an amount of from 20 to 70 mol %. In some embodiments, the electrolyte composition is the electrolyte composition wherein the primary solvent is present in the electrolyte composition in an amount of from 30 to 60 mol %. In some embodiments, the electrolyte composition is the electrolyte composition wherein the primary solvent is present in the electrolyte composition in an amount of from 35 to 55 mol %. In some embodiments, the electrolyte composition is the electrolyte composition wherein the primary solvent is present in the electrolyte composition in an amount of from 35 to 50 mol %. In some embodiments, the electrolyte composition is the electrolyte composition wherein the primary solvent is present in the electrolyte composition in an amount of from 35 to 50 mol %. In some embodiments, the electrolyte composition is the electrolyte composition wherein the primary solvent is present in the electrolyte composition in an amount of from 35 to 45 mol %. In some embodiments, the electrolyte composition is the electrolyte composition wherein the primary solvent is present in the electrolyte composition in an amount of from 45 to 50 mol %.

The electrolyte composition of the present invention can include one or more primary solvents. For example, the electrolyte composition can include 1, 2, 3, 4, or more different primary solvents as defined above. In some embodiments, the electrolyte composition is the electrolyte composition comprising one primary solvent. In some embodiments, the electrolyte composition is the electrolyte composition comprising two different primary solvents. In some embodiments, the electrolyte composition is the electrolyte composition comprising three different primary solvents.

### Mediating Solvent

The mediating solvent useful in the electrolyte compositions of the present invention has a low to moderate Li⁺ coordination strength and is substantially miscible with the primary solvent and diluent. Representative mediating solvents include, but are not limited to, a fluorinated ether, a fluorinated glyme, a fluorinated cyclic ether, or combinations thereof, wherein the ether, glyme, and cyclic ether are as defined above. The fluorinated mediating solvents can be fully or partially fluorinated.

In some embodiments, the electrolyte composition is the electrolyte composition wherein the mediating solvent comprises a fluorinated ether, a fluorinated glyme, a fluorinated cyclic ether, or combinations thereof. The mediating solvent can have a calculated Li⁺ coordination energy of from −10 to −50, from −15 to −45, from −20 to −40, or from −30 to −40.

In some embodiments, the electrolyte composition is the electrolyte composition wherein the mediating solvent has the formula of

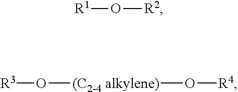

or combinations thereof, wherein
R¹ and R² are each independently C₁₋₆ haloalkyl;
R³ and R⁴ are each independently C₁₋₆ alkyl or C₁₋₆ haloalkyl; and
the alkylene is substituted with 0 to 8 fluoro groups,
wherein at least one of R³ and R⁴ is C₁₋₆ haloalkyl, or alkylene is substituted with 1 to 8 fluoro groups.

In some embodiments, the electrolyte composition is the electrolyte composition wherein the mediating solvent comprises 2,2,3,3-tetrafluoro-1,4-dimethoxybutane, 2-(2-ethoxyethoxy)-1,1,1-trifluoroethane, 1,2-bis(2,2-difluoroethoxy)ethane, 1,2-bis(2,2,2-trifluoroethoxy)ethane, 1H,1H,5H-octafluoropentyl 1,1,2,2-tetrafluoroethyl ether, 2-(2-(2,2-difluoroethoxy)ethoxy)-1,1,1-trifluoroethane, or combinations thereof. In some embodiments, the electrolyte composition is the electrolyte composition wherein the mediating solvent comprises 2,2,3,3-tetrafluoro-1,4-dimethoxybutane, 1,2-bis(2,2-difluoroethoxy)ethane, 1H,1H,5H-octafluoropentyl 1,1,2,2-tetrafluoroethyl ether, 2-(2-(2,2-difluoroethoxy)ethoxy)-1,1,1-trifluoroethane, or combinations thereof. In some embodiments, the electrolyte composition is the electrolyte composition wherein the mediating solvent comprises 1H,1H,5H-octafluoropentyl 1,1,2,2-tetrafluoroethyl ether, 2-(2-(2,2-difluoroethoxy)ethoxy)-1,1,1-trifluoroethane, or combinations thereof. In some embodiments, the electrolyte composition is the electrolyte composition wherein the mediating solvent comprises 2,2,3,3-tetrafluoro-1,4-dimethoxybutane, 1,2-bis(2,2-difluoroethoxy)ethane, 1H,1H,5H-octafluoropentyl 1,1,2,2-tetrafluoroethyl ether, 2-(2-(2,2-difluoroethoxy)ethoxy)-1,1,1-trifluoroethane, or combinations thereof. In some embodiments, the electrolyte composition is the electrolyte composition wherein the mediating solvent comprises 1H,1H,5H-octafluoropentyl 1,1,2,2-tetrafluoroethyl ether. In some embodiments, the electrolyte composition is the electrolyte composition wherein the mediating solvent comprises 2-(2-(2,2-difluoroethoxy)ethoxy)-1,1,1-trifluoroethane.

In some embodiments, the mediating solvent of the present invention can have the formula:

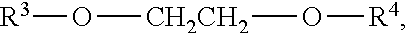

wherein R³ and R⁴ are each independently C₁₋₆ alkyl or C₁₋₆ haloalkyl. In some embodiments, the electrolyte composition includes the mediating solvent wherein R³ and R⁴ are each independently C₂₋₄ alkyl or C₂₋₄ haloalkyl. In some embodiments, the electrolyte composition includes the mediating solvent wherein R³ and R⁴ are each independently C₂ alkyl or C₂ haloalkyl. In some embodiments, the electrolyte composition includes the mediating solvent wherein R³ and R⁴ are each independently C₂ haloalkyl.

In some embodiments, the electrolyte composition includes the mediating solvent wherein R³ and R⁴ are each independently ethyl, 1-fluoroethyl, 1,1-difluoroethyl, 1,1,1-trifluoroethyl, 1,2-difluoroethyl, 1,1,2-trifluoroethyl, 1,1,1,2-tetrafluoroethyl, 1,2,2-trifluoroethyl, 1,1,2,2-tetrafluoroethyl, or 1,1,1,2,2-pentafluoroethyl. In some embodiments, the electrolyte composition includes the mediating solvent wherein R³ and R⁴ are different.

In some embodiments, the electrolyte composition is the electrolyte composition wherein the mediating solvent includes 1-(2-ethoxyethoxy)-2-fluoroethane, 1-(2-ethoxyethoxy)-2,2-difluoroethane, 1-(2-ethoxyethoxy)-2,2,2-trifluoroethane, 1-(2-ethoxyethoxy)-1,2-difluoroethane, 1-(2-ethoxyethoxy)-1,2,2-trifluoroethane, 1-(2-ethoxyethoxy)-1,2,2,2-tetrafluoroethane, 1-(2-ethoxyethoxy)-1,1,2-trifluoroethane, 1-(2-ethoxyethoxy)-1,1,2,2-tetrafluoroethane, or 1-(2-ethoxyethoxy)-1,1,2,2,2-pentafluoroethane.

In some embodiments, the electrolyte composition is the electrolyte composition wherein the mediating solvent includes 1,2-bis(2-fluoroethoxy)ethane, 1,1-difluoro-2-(2-(2-fluoroethoxy)ethoxy)ethane, 1,1,1-trifluoro-2-(2-(2-fluoroethoxy)ethoxy)ethane, 1,2-difluoro-2-(2-(2-fluoroethoxy)ethoxy)ethane, 1,1,2-trifluoro-2-(2-(2-fluoroethoxy)ethoxy)ethane, 1,1,1,2-tetrafluoro-2-(2-(2-fluoroethoxy)ethoxy)ethane, 1,2,2-trifluoro-2-(2-(2-fluoroethoxy)ethoxy)ethane, 1,1,2,2-tetrafluoro-2-(2-(2-fluoroethoxy)ethoxy)ethane, or 1,1,1,2,2-pentafluoro-2-(2-(2-fluoroethoxy)ethoxy)ethane.

In some embodiments, the electrolyte composition is the electrolyte composition wherein the mediating solvent includes 1,2-bis(2,2-difluoroethoxy)ethane, 1,1,1-trifluoro-2-(2-(2,2-difluoroethoxy)ethoxy)ethane, 1,2-difluoro-2-(2-(2,2-difluoroethoxy)ethoxy)ethane, 1,1,2-trifluoro-2-(2-(2,2-difluoroethoxy)ethoxy)ethane, 1,1,1,2-tetrafluoro-2-(2-(2,2-difluoroethoxy)ethoxy)ethane, 1,2,2-trifluoro-2-(2-(2,2-difluoroethoxy)ethoxy)ethane, 1,1,2,2-tetrafluoro-2-(2-(2,2-difluoroethoxy)ethoxy)ethane, or 1,1,1,2,2-pentafluoro-2-(2-(2,2-difluoroethoxy)ethoxy)ethane.

In some embodiments, the electrolyte composition is the electrolyte composition wherein the mediating solvent includes 1,2-bis(2,2,2-trifluoroethoxy)ethane, 1,2-difluoro-2-(2-(2,2,2-trifluoroethoxy)ethoxy)ethane, 1,1,2-trifluoro-2-(2-(2,2,2-trifluoroethoxy)ethoxy)ethane, 1,1,1,2-tetrafluoro-2-(2-(2,2,2-trifluoroethoxy)ethoxy)ethane, 1,2,2-trifluoro-2-(2-(2,2,2-trifluoroethoxy)ethoxy)ethane, 1,1,2,2-tetrafluoro-2-(2-(2,2,2-trifluoroethoxy)ethoxy)ethane, or 1,1,1,2,2-pentafluoro-2-(2-(2,2,2-trifluoroethoxy)ethoxy)ethane.

The mediating solvent can be present in the electrolyte composition in any suitable amount. For example, the mediating solvent can be present in the electrolyte composition in an amount of from 1 to 50 mol %, from 1 to 40 mol %, from 1 to 30 mol %, from 5 to 25 mol %, from 5 to 20 mol %, from 10 to 20 mol %, from 10 to 15 mol %, from 15 to 20 mol %, from 5 to 15 mol %, or from 5 to 10 mol %. Representative amounts of the mediating solvent in the electrolyte composition include, but are not limited to, about 5 mol %, or about 6, 7, 8, 9, 10, 11, 12, 13, 14, 15, 16, 17, 18, 19, 20, 21, 22, 23, 24, or about 25 mol %.

In some embodiments, the electrolyte composition is the electrolyte composition wherein the mediating solvent is present in the electrolyte composition in an amount of from 1 to 30 mol %. In some embodiments, the electrolyte composition is the electrolyte composition wherein the mediating solvent is present in the electrolyte composition in an amount of from 5 to 20 mol %. In some embodiments, the electrolyte composition is the electrolyte composition in an amount of from 10 to 20 mol %. In some embodiments, the electrolyte composition is the electrolyte composition in an amount of from 5 to 10 mol %. In some embodiments, the electrolyte composition is the electrolyte composition in an amount of from 15 to 20 mol %.

The electrolyte composition of the present invention can include one or more mediating solvents. For example, the electrolyte composition can include 1, 2, 3, 4, or more different mediating solvents as defined above. In some embodiments, the electrolyte composition is the electrolyte composition comprising one mediating solvent. In some embodiments, the electrolyte composition is the electrolyte composition comprising two different mediating solvents. In some embodiments, the electrolyte composition is the electrolyte composition comprising three different mediating solvents.

### Diluent

The diluent useful in the electrolyte compositions of the present invention has a relatively low Li⁺ coordination strength compared to the primary solvent and mediating solvent, thus allowing the primary solvent to occupy the first solvation shell of Li⁺. Representative diluents include, but are not limited to, a fluorinated ether, a fluorinated glyme, a cyclic ether, a fluorinated cyclic ether, or combinations thereof, wherein the ether, glyme, and cyclic ether are as defined above. The fluorinated diluent can be fully or partially fluorinated.

In some embodiments, the electrolyte composition is the electrolyte composition wherein the diluent comprises a fluorinated ether, a fluorinated glyme, a cyclic ether, a fluorinated cyclic ether, or combinations thereof. In some embodiments, the electrolyte composition is the electrolyte composition wherein the diluent is a fluorinated ether, a fluorinated glyme, a cyclic ether, a fluorinated cyclic ether, or combinations thereof. The diluent can have a calculated Li⁺ coordination energy of from −10 to −50, from −15 to −45, from −20 to −40, or from −25 to −35.

In some embodiments, the electrolyte composition is the electrolyte composition wherein the diluent has the formula of

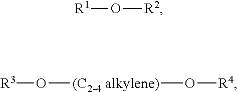

or combinations thereof, wherein
R¹ and R² are each independently C₁₋₆ haloalkyl;
alternatively, R¹ and R² can be combined to form a heterocycloalkyl having 5 to 6 ring members and 0 to 3 additional heteroatoms each independently O;
R³ and R⁴ are each independently C₁₋₆ alkyl or C₁₋₆ haloalkyl; and
the alkylene is substituted with 0 to 8 fluoro groups,
wherein at least one of R³ and R⁴ is C₁₋₆ haloalkyl, or alkylene is substituted with 1 to 8 fluoro groups.

In some embodiments, the electrolyte composition is the electrolyte composition wherein the diluent comprises 1,1,2,2-tetrafluoroethyl 2,2,3,3-tetrafluoropropyl ether, 1H,1H,5H-octafluoropentyl 1,1,2,2-tetrafluoroethyl ether, or combinations thereof. In some embodiments, the electrolyte composition is the electrolyte composition wherein the diluent is 1,1,2,2-tetrafluoroethyl 2,2,3,3-tetrafluoropropyl ether, 1H,1H,5H-octafluoropentyl 1,1,2,2-tetrafluoroethyl ether, or combinations thereof. In some embodiments, the electrolyte composition is the electrolyte composition wherein the diluent comprises 1,1,2,2-tetrafluoroethyl 2,2,3,3-tetrafluoropropyl ether, 1H,1H,5H-octafluoropentyl 1,1,2,2-tetrafluoroethyl ether, or combinations thereof. In some embodiments, the electrolyte composition is the electrolyte composition wherein the diluent is 1,1,2,2-tetrafluoroethyl 2,2,3,3-tetrafluoropropyl ether, 1H,1H,5H-octafluoropentyl 1,1,2,2-tetrafluoroethyl ether, or combinations thereof. In some embodiments, the electrolyte composition is the electrolyte composition wherein the diluent comprises 1,1,2,2-tetrafluoroethyl 2,2,3,3-tetrafluoropropyl ether.

In some embodiments, the diluent of the present invention can have the formula:

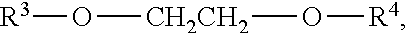

wherein R³ and R⁴ are each independently C₁₋₆ alkyl or C₁₋₆ haloalkyl. In some embodiments, the electrolyte composition includes the diluent wherein R³ and R⁴ are each independently C₂₋₄ alkyl or C₂₋₄ haloalkyl. In some embodiments, the electrolyte composition includes the diluent wherein R³ and R⁴ are each independently C₂ alkyl or C₂ haloalkyl. In some embodiments, the electrolyte composition includes the diluent wherein R³ and R⁴ are each independently C₂ haloalkyl.

In some embodiments, the electrolyte composition includes the diluent wherein R³ and R⁴ are each independently ethyl, 1-fluoroethyl, 1,1-difluoroethyl, 1,1,1-trifluoroethyl, 1,2-difluoroethyl, 1,1,2-trifluoroethyl, 1,1,1,2-tetrafluoroethyl, 1,2,2-trifluoroethyl, 1,1,2,2-tetrafluoroethyl, or 1,1,1,2,2-pentafluoroethyl. In some embodiments, the electrolyte composition includes the diluent wherein R³ and R⁴ are different.

In some embodiments, the electrolyte composition is the electrolyte composition wherein the diluent includes 1-(2-ethoxyethoxy)-2-fluoroethane, 1-(2-ethoxyethoxy)-2,2-difluoroethane, 1-(2-ethoxyethoxy)-2,2,2-trifluoroethane, 1-(2-ethoxyethoxy)-1,2-difluoroethane, 1-(2-ethoxyethoxy)-1,2,2-trifluoroethane, 1-(2-ethoxyethoxy)-1,2,2,2-tetrafluoroethane, 1-(2-ethoxyethoxy)-1,1,2-trifluoroethane, 1-(2-ethoxyethoxy)-1,1,2,2-tetrafluoroethane, or 1-(2-ethoxyethoxy)-1,1,2,2,2-pentafluoroethane.

In some embodiments, the electrolyte composition is the electrolyte composition wherein the diluent includes 1,2-bis(2-fluoroethoxy)ethane, 1,1-difluoro-2-(2-(2-fluoroethoxy)ethoxy)ethane, 1,1,1-trifluoro-2-(2-(2-fluoroethoxy)ethoxy)ethane, 1,2-difluoro-2-(2-(2-fluoroethoxy)ethoxy)ethane, 1,1,2-trifluoro-2-(2-(2-fluoroethoxy)ethoxy)ethane, 1,1,1,2-tetrafluoro-2-(2-(2-fluoroethoxy)ethoxy)ethane, 1,2,2-trifluoro-2-(2-(2-fluoroethoxy)ethoxy)ethane, 1,1,2,2-tetrafluoro-2-(2-(2-fluoroethoxy)ethoxy)ethane, or 1,1,1,2,2-pentafluoro-2-(2-(2-fluoroethoxy)ethoxy)ethane.

In some embodiments, the electrolyte composition is the electrolyte composition wherein the diluent includes 1,2-bis(2,2-difluoroethoxy)ethane, 1,1,1-trifluoro-2-(2-(2,2-difluoroethoxy)ethoxy)ethane, 1,2-difluoro-2-(2-(2,2-difluoroethoxy)ethoxy)ethane, 1,1,2-trifluoro-2-(2-(2,2-difluoroethoxy)ethoxy)ethane, 1,1,1,2-tetrafluoro-2-(2-(2,2-difluoroethoxy)ethoxy)ethane, 1,2,2-trifluoro-2-(2-(2,2-difluoroethoxy)ethoxy)ethane, 1,1,2,2-tetrafluoro-2-(2-(2,2-difluoroethoxy)ethoxy)ethane, or 1,1,1,2,2-pentafluoro-2-(2-(2,2-difluoroethoxy)ethoxy)ethane.

In some embodiments, the electrolyte composition is the electrolyte composition wherein the diluent includes 1,2-bis(2,2,2-trifluoroethoxy)ethane, 1,2-difluoro-2-(2-(2,2,2-trifluoroethoxy)ethoxy)ethane, 1,1,2-trifluoro-2-(2-(2,2,2-trifluoroethoxy)ethoxy)ethane, 1,1,1,2-tetrafluoro-2-(2-(2,2,2-trifluoroethoxy)ethoxy)ethane, 1,2,2-trifluoro-2-(2-(2,2,2-trifluoroethoxy)ethoxy)ethane, 1,1,2,2-tetrafluoro-2-(2-(2,2,2-trifluoroethoxy)ethoxy)ethane, or 1,1,1,2,2-pentafluoro-2-(2-(2,2,2-trifluoroethoxy)ethoxy)ethane.

The diluent can be present in the electrolyte composition in any suitable amount.

For example, the diluent can be present in the electrolyte composition in an amount of from 1 to 50 mol %, from 1 to 40 mol %, from 1 to 30 mol %, from 5 to 25 mol %, from 5 to 20 mol %, from 10 to 20 mol %, from 10 to 15 mol %, or from 15 to 20 mol %. Representative amounts of the diluent in the electrolyte composition include, but are not limited to, about 5 mol %, or about 6, 7, 8, 9, 10, 11, 12, 13, 14, 15, 16, 17, 18, 19, or 20 mol %.

In some embodiments, the electrolyte composition is the electrolyte composition wherein the diluent is present in the electrolyte composition in an amount of from 1 to 30 mol %. In some embodiments, the electrolyte composition is the electrolyte composition wherein the diluent is present in the electrolyte composition in an amount of from 5 to 20 mol %. In some embodiments, the electrolyte composition is the electrolyte composition wherein the diluent is present in an amount of from 5 to 15 mol %. In some embodiments, the electrolyte composition is the electrolyte composition wherein the diluent is present in an amount of from 9 to 14% mol %.

The electrolyte composition of the present invention can include one or more diluents. For example, the electrolyte composition can include 1, 2, 3, 4, or more different diluents as defined above. In some embodiments, the electrolyte composition is the electrolyte composition comprising a single diluent. In some embodiments, the electrolyte composition is the electrolyte composition comprising two different diluents. In some embodiments, the electrolyte composition is the electrolyte composition comprising three different diluents.

### Lithium Salt

The lithium salt of the electrolyte compositions of the present invention can be any suitable lithium salt. For example, suitable lithium salts include, but are not limited to, lithium bis(fluorosulfonyl)imide, lithium hexafluorophosphate, lithium 4,5-dicyano-2-(trifluoromethyl)imidazolium, lithium difluoro(oxalato)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof. In some embodiments, the lithium salt can be lithium bis(fluorosulfonyl)imide, lithium hexafluorophosphate, lithium 4,5-dicyano-2-(trifluoromethyl)imidazolium, lithium difluoro(oxalato)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof.

In some embodiments, the electrolyte composition is the electrolyte composition wherein the first lithium salt includes lithium bis(fluorosulfonyl)imide (LiFSi), lithium hexafluorophosphate, or combinations thereof. In some embodiments, the electrolyte composition is the electrolyte composition wherein the first lithium salt includes lithium bis(fluorosulfonyl)imide (LiFSi).

The first lithium salt can be present in the electrolyte composition in any suitable amount. For example, the first lithium salt can be present in the electrolyte composition in an amount of from 1 to 50 mol %, from 5 to 50 mol %, from 10 to 50 mol %, from 15 to 45 mol %, from 20 to 40 mol %, from 25 to 35 mol %, or from 25 to 30 mol %. Representative amounts of the first lithium salt in the electrolyte compositions of the present invention include, but are not limited to, about 20 mol %, or about 21, 22, 23, 24, 25, 26, 27, 28, 29, 30, 31, 32, 33, 34, or about 35 mol %.

In some embodiments, the electrolyte composition is the electrolyte composition wherein the first lithium salt is present in the electrolyte composition in an amount of from 10 to 50 mol %. In some embodiments, the electrolyte composition is the electrolyte composition wherein the first lithium salt is present in the electrolyte composition in an amount of from 20 and 40 mol %, In some embodiments, the electrolyte composition is the electrolyte composition wherein the first lithium salt is present in the electrolyte composition in an amount of from 25 to 35 mol %. In some embodiments, the electrolyte composition is the electrolyte composition wherein the first lithium salt is present in the electrolyte composition in an amount of from 25 and 30 mol %.

The first lithium salt can be present in the electrolyte compositions of the present invention in any suitable ratio to the primary solvent. For example, the molar ratio of the primary solvent to the first lithium salt in the electrolyte compositions of the present invention can be from 10:1 to 1:1, from 5:1 to 1.1:1, from 4.5:1 to 1.2:1, from 4:1 to 1.3:1, from 3.5:1 to 1.4:1, from 3:1 to 1.4:1, from 2.5:1 to 1:4:1, or from 2:1 to 1.4:1. Representative molar ratios of the primary solvent to the first lithium salt in the electrolyte compositions of the present invention can be about 2:1, or about 1.9:1, 1.8:1, 1.7:1, 1.6:1, 1.5:1, 1.4:1, 1.3:1, 1.2:1, 1.1:1, or about 1:1.

In some embodiments, the electrolyte composition is the electrolyte composition wherein the molar ratio of the primary solvent to the first lithium salt is from 3.5:1 to 1.4:1. In some embodiments, the electrolyte composition is the electrolyte composition wherein the molar ratio of the primary solvent to the first lithium salt is from 2.0:1 to 1.4:1.

The electrolyte composition of the present invention can include one or more lithium salts. For example, the electrolyte composition can include 1, 2, 3, 4, or more different lithium salts as defined above. In some embodiments, the electrolyte composition is the electrolyte composition comprising a single lithium salt. In some embodiments, the electrolyte composition is the electrolyte composition comprising two different lithium salts. In some embodiments, the electrolyte composition is the electrolyte composition comprising three different lithium salts.

The electrolyte compositions of the present invention can also include a second lithium salt that is different from the first lithium salt. In some embodiments, the electrolyte composition is the electrolyte composition including a second lithium salt that is different from the first lithium salt.

In some embodiments, the electrolyte composition is the electrolyte composition wherein the second lithium salt comprises lithium 4,5-dicyano-2-(trifluoromethyl)imidazolium, lithium difluoro(oxalato)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof. In some embodiments, the electrolyte composition is the electrolyte composition wherein the second lithium salt comprises lithium 4,5-dicyano-2-(trifluoromethyl)imidazolium, lithium difluoro(oxalato)borate, or combinations thereof. In some embodiments, the electrolyte composition is the electrolyte composition wherein the second lithium salt comprises lithium 4,5-dicyano-2-(trifluoromethyl)imidazolium. In some embodiments, the electrolyte composition is the electrolyte composition wherein the second lithium salt comprises lithium difluoro(oxalato)borate. In some embodiments, the electrolyte composition is the electrolyte composition wherein the second lithium salt comprises lithium nitrate.

The second lithium salt can be present in the electrolyte composition in any suitable amount. For example, the second lithium salt can be present in the electrolyte composition in an amount of from 0.1 to 10 mol %, from 0.1 to 5 mol %, from 0.5 to 5 mol %, from 0.5 to 4 mol %, from 0.5 to 3.5 mol %, from 1 to 3 mol %, from 1.0 to 2.5 mol %, or from 1.5 to 2.5 mol %. Representative amounts of the second lithium salt in the electrolyte compositions of the present invention include, but are not limited to, about 1.5 mol %, or about 1.6, 1.7, 1.8, 1.9, 2.0, 2.1, 2.2, 2.3, 2.4, or about 2.5 mol %.

In some embodiments, the electrolyte composition is the electrolyte composition wherein the second lithium salt is present in the electrolyte composition in an amount of from 0.1 to 5 mol %. In some embodiments, the electrolyte composition is the electrolyte composition wherein the second lithium salt is present in the electrolyte composition in an amount of from 0.5 to 3.5 mol %. In some embodiments, the electrolyte composition is the electrolyte composition wherein the second lithium salt is present in the electrolyte composition in an amount of 1 to 3 mol %. In some embodiments, the electrolyte composition is the electrolyte composition wherein the second lithium salt is present in the electrolyte composition in an amount of from 1.5 to 2.5 mol %.

### Additive

The electrolyte composition of the present invention can also include an additive. In some embodiments, the electrolyte composition is the electrolyte composition including an additive. The electrolyte composition of the present invention can also include an additive. In some embodiments, the electrolyte composition is the electrolyte composition including an additive. Without being bound to any particular theory, the additive can be selected to preferentially decompose via reduction at the anode surface to provide a preferred solid electrolyte interphase. Such additives can have a LUMO energy which is less than 0.5 eV. Alternatively, the additive can be selected to preferentially decompose via oxidation at the cathode surface to provide a preferred cathode electrolyte interphase. Such additives can have a HOMO energy greater than [−7.5 eV] or the oxidation potential is less than [6.5 V]. The additive can also be selected be both reduced at the anode and oxidized at the cathode, providing both a preferred solid electrolyte interphase and preferred cathode electrolyte interphase. Alternatively, the additive can be selected to bind or network working ions or solvation clusters. Additives can also be selected to preferentially bind anions at Lewis acidic sites, wherein the electrostatic potential is substantially positive. When the additive is a Lewis acid additive, the additive can be selected to bind or network anions to increase transference number. In some embodiments, the additive is selected to reduce viscosity. In some embodiments, the additive is selected to increase conductivity. One of ordinary skill will recognize that these mechanisms are orthogonal, and therefore a single additive may be selected to provide several mechanisms to improve electrolyte performance. Alternatively, several additives can be included in the electrolyte composition to provide the same or different mechanisms to improve electrolyte performance.

Without being bound to any particular theory, the additive can be selected to preferentially decompose at the anode surface, the cathode surface, or both electrode surfaces, providing a preferred solid electrolyte interphase, to bind or network working ions or solvation clusters, and to bind or network anions to increase transference number. In some embodiments, the additive is selected to reduce viscosity. In some embodiments, the additive is selected to increase conductivity.

In some embodiments, the electrolyte composition is the electrolyte composition wherein the additive comprises 1,3,2-Dioxathiane 2,2-dioxide, 1,3,2-Dioxathiolane 2,2-dioxide, 2-fluoropyridine, bis(trimethylsilyl) malonate, dimethylacetamide, phenyltrifluorosilane, ethoxy(pentafluoro)triphosphazine, fluoroethylene carbonate, p-tolylsulfur pentafluoride, succinonitrile, tetrafluoroterephthalonitrile, tolylene-2,4-diisocyanate, tolylene-2,6-diisocyanate, tris(trimethylsilyl) phosphate, or combinations thereof. In some embodiments, the electrolyte composition is the electrolyte composition wherein the additive comprises 1,3,2-Dioxathiane 2,2-dioxide. In some embodiments, the electrolyte composition is the electrolyte composition wherein the additive comprises 1,3,2-Dioxathiolane 2,2-dioxide. In some embodiments, the electrolyte composition is the electrolyte composition wherein the additive comprises ethoxy(pentafluoro)triphosphazine. In some embodiments, the electrolyte composition is the electrolyte composition wherein the additive comprises tris(trimethylsilyl) phosphate.

The additive can be present in the electrolyte composition of the present invention in any suitable amount. For example, the additive can be present in the electrolyte composition of the present invention in an amount of from 0.1 to 10 mol %, from 0.1 to 5 mol %, from 0.1 to 4 mol %, from 0.1 to 3 mol %, from 0.5 to 3 mol %, from 0.1 to 2.5 mol %, from 0.5 to 2.5 mol %, from 0.8 to 2.5 mol %, from 0.1 to 2 mol %, or from 0.5 to 1.5 mol %.

Representative amounts of the additive in the electrolyte compositions of the present invention include, but are not limited to, about 0.3 mol %, or about 0.4, 0.5, 0.6, 0.7, 0.8, 0.9, 1.0, 1.1, 1.2, 1.3, 1.4 or about 1.5 mol %.

In some embodiments, the electrolyte composition is the electrolyte composition wherein the additive is present in the electrolyte composition in an amount of from 0.1 to 5 mol %. In some embodiments, the electrolyte composition is the electrolyte composition wherein the additive is present in the electrolyte composition in an amount of from 0.5 to 3 mol %. In some embodiments, the electrolyte composition is the electrolyte composition wherein the additive is present in the electrolyte composition in an amount of from 0.8 to 2.5 mol %.

The electrolyte composition of the present invention can include one or more additives. For example, the electrolyte composition can include 1, 2, 3, 4, or more different additives as defined above. In some embodiments, the electrolyte composition is the electrolyte composition comprising a single additive. In some embodiments, the electrolyte composition is the electrolyte composition comprising two different additives. In some embodiments, the electrolyte composition is the electrolyte composition comprising three different additives.

### Electrolyte Compositions

In some embodiments, the electrolyte composition is the electrolyte composition comprising:
the primary solvent is an ether, a glyme, a cyclic ether, or combinations thereof;
the mediating solvent is a fluorinated ether, a fluorinated glyme, a fluorinated cyclic ether, or combinations thereof;
the diluent is a fluorinated ether, a fluorinated glyme, a cyclic ether, a fluorinated cyclic ether, or combinations thereof; and
the first lithium salt.

In some embodiments, the electrolyte composition is the electrolyte composition comprising:
the primary solvent in an amount of from 20 to 70 mol %;
the mediating solvent in an amount of from 1 to 30 mol %;
the diluent in an amount of from 1 to 30 mol. %; and
the first lithium salt in an amount of from 10 to 50 mol %.

In some embodiments, the electrolyte composition is the electrolyte composition comprising:
the primary solvent is an ether, a glyme, a cyclic ether, or combinations thereof, wherein the primary solvent is present in an amount of from 20 to 70 mol %;
the mediating solvent is a fluorinated ether, a fluorinated glyme, a fluorinated cyclic ether, or combinations thereof, wherein the mediating solvent is present in an amount of from 1 to 30 mol %;
the diluent is a fluorinated ether, a fluorinated glyme, a cyclic ether, a fluorinated cyclic ether, or combinations thereof, wherein the diluent is present in an amount of from 1 to 30 mol. %; and
the first lithium salt in an amount of from 10 to 50 mol %.

In some embodiments, the electrolyte composition is the electrolyte composition comprising:
the primary solvent is diethylether, 1,2-dimethoxyethane, 1,2-diethoxyethane, 1,3-dioxolane, 1,4-dioxane, 1,3-dioxane, or combinations thereof;
the mediating solvent 2,2,3,3-tetrafluoro-1,4-dimethoxybutane, 1,2-bis(2,2-difluoroethoxy)ethane, 1H,1H,5H-octafluoropentyl 1,1,2,2-tetrafluoroethyl ether, 2-(2-(2,2-difluoroethoxy)ethoxy)-1,1,1-trifluoroethane, or combinations thereof;
the diluent is 1,1,2,2-tetrafluoroethyl 2,2,3,3-tetrafluoropropyl ether, 1H,1H,5H-octafluoropentyl 1,1,2,2-tetrafluoroethyl ether, or combinations thereof; and
the first lithium salt is lithium bis(fluorosulfonyl)imide, lithium hexafluorophosphate, lithium 4,5-dicyano-2-(trifluoromethyl)imidazolium, lithium difluoro(oxalato)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof.

In some embodiments, the electrolyte composition is the electrolyte composition comprising:
the primary solvent is diethylether, 1,2-dimethoxyethane, 1,2-diethoxyethane, 1,3-dioxolane, 1,4-dioxane, 1,3-dioxane, or combinations thereof, wherein the primary solvent is present in an amount of from 20 to 70 mol %;
the mediating solvent 2,2,3,3-tetrafluoro-1,4-dimethoxybutane, 1,2-bis(2,2-difluoroethoxy)ethane, 1H,1H,5H-octafluoropentyl 1,1,2,2-tetrafluoroethyl ether, 2-(2-(2,2-difluoroethoxy)ethoxy)-1,1,1-trifluoroethane, or combinations thereof, wherein the mediating solvent is present in an amount of from 1 to 30 mol %;
the diluent is 1,1,2,2-tetrafluoroethyl 2,2,3,3-tetrafluoropropyl ether, 1H,1H,5H-octafluoropentyl 1,1,2,2-tetrafluoroethyl ether, or combinations thereof, wherein the diluent is present in an amount of from 1 to 30 mol. %; and
the first lithium salt is lithium bis(fluorosulfonyl)imide, lithium hexafluorophosphate, lithium 4,5-dicyano-2-(trifluoromethyl)imidazolium, lithium difluoro(oxalato)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof, wherein the first lithium salt is present in an amount of from 10 to 50 mol %.

In some embodiments, the electrolyte composition is the electrolyte composition consisting essentially of: the primary solvent; the mediating solvent; the diluent; the first lithium salt; optionally the second lithium salt; and optionally the additive. In some embodiments, the electrolyte composition is the electrolyte composition consisting of: the primary solvent; the mediating solvent; the diluent; the first lithium salt; optionally the second lithium salt; and optionally the additive.

In some embodiments, the electrolyte composition is the electrolyte composition comprising: the primary solvent; the mediating solvent; the diluent; the first lithium salt; the second lithium salt; and the additive.

In some embodiments, the electrolyte composition is the electrolyte composition comprising:
the primary solvent is diethylether, 1,2-dimethoxyethane, 1,2-diethoxyethane, 1,3-dioxolane, 1,4-dioxane, 1,3-dioxane, or combinations thereof;
the mediating solvent 2,2,3,3-tetrafluoro-1,4-dimethoxybutane, 1,2-bis(2,2-difluoroethoxy)ethane, 1H,1H,5H-octafluoropentyl 1,1,2,2-tetrafluoroethyl ether, 2-(2-(2,2-difluoroethoxy)ethoxy)-1,1,1-trifluoroethane, or combinations thereof;
the diluent is 1,1,2,2-tetrafluoroethyl 2,2,3,3-tetrafluoropropyl ether, 1H,1H,5H-octafluoropentyl 1,1,2,2-tetrafluoroethyl ether, or combinations thereof;
the first lithium salt is lithium bis(fluorosulfonyl)imide, lithium hexafluorophosphate, lithium 4,5-dicyano-2-(trifluoromethyl)imidazolium, lithium difluoro(oxalato)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof;
the second lithium salt is lithium 4,5-dicyano-2-(trifluoromethyl)imidazolium, lithium difluoro(oxalato)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof; and
the additive is 1,3,2-Dioxathiane 2,2-dioxide, 1,3,2-Dioxathiolane 2,2-dioxide, 2-fluoropyridine, bis(trimethylsilyl) malonate, dimethylacetamide, phenyltrifluorosilane, ethoxy(pentafluoro)triphosphazine, fluoroethylene carbonate, p-tolylsulfur pentafluoride, succinonitrile, tetrafluoroterephthalonitrile, tolylene-2,4-diisocyanate, tolylene-2,6-diisocyanate, tris(trimethylsilyl) phosphate, or combinations thereof.

In some embodiments, the electrolyte composition is the electrolyte composition comprising:
the primary solvent in an amount of from 20 to 70 mol %;
the mediating solvent in an amount of from 1 to 30 mol %;
the diluent in an amount of from 1 to 30 mol. %;
the first lithium salt in an amount of from 10 to 50 mol %;
the second lithium salt in an amount of from 0.1 to 5 mol %; and
the additive in an amount of from 0.1 to 5 mol %.

In some embodiments, the electrolyte composition is the electrolyte composition comprising:
the primary solvent is diethylether, 1,2-dimethoxyethane, 1,2-diethoxyethane, 1,3-dioxolane, 1,4-dioxane, 1,3-dioxane, or combinations thereof, wherein the primary solvent is present in an amount of from 20 to 70 mol %;
the mediating solvent 2,2,3,3-tetrafluoro-1,4-dimethoxybutane, 1,2-bis(2,2-difluoroethoxy)ethane, 1H,1H,5H-octafluoropentyl 1,1,2,2-tetrafluoroethyl ether, 2-(2-(2,2-difluoroethoxy)ethoxy)-1,1,1-trifluoroethane, or combinations thereof, wherein the mediating solvent is present in an amount of from 1 to 30 mol %;
the diluent is 1,1,2,2-tetrafluoroethyl 2,2,3,3-tetrafluoropropyl ether, 1H,1H,5H-octafluoropentyl 1,1,2,2-tetrafluoroethyl ether, or combinations thereof, wherein the diluent is present in an amount of from 1 to 30 mol. %;
the first lithium salt is lithium bis(fluorosulfonyl)imide, lithium hexafluorophosphate, lithium 4,5-dicyano-2-(trifluoromethyl)imidazolium, lithium difluoro(oxalato)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof, wherein the first lithium salt is present in an amount of from 10 to 50 mol %;
the second lithium salt is lithium 4,5-dicyano-2-(trifluoromethyl)imidazolium, lithium difluoro(oxalato)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof, wherein the second lithium salt is present in an amount of from 0.1 to 5 mol %; and
the additive is 1,3,2-Dioxathiane 2,2-dioxide, 1,3,2-Dioxathiolane 2,2-dioxide, 2-fluoropyridine, bis(trimethylsilyl) malonate, dimethylacetamide, phenyltrifluorosilane, ethoxy(pentafluoro)triphosphazine, fluoroethylene carbonate, p-tolylsulfur pentafluoride, succinonitrile, tetrafluoroterephthalonitrile, tolylene-2,4-diisocyanate, tolylene-2,6-diisocyanate, tris(trimethylsilyl) phosphate, or combinations thereof, wherein the additive is present in an amount of from 0.1 to 5 mol %.

In some embodiments, the electrolyte composition is the electrolyte composition comprising:
the primary solvent in an amount of from 35 to 50 mol %;
the mediating solvent in an amount of from 5 to 20 mol %;
the diluent in an amount of from 5 to 20 mol %; and
the first lithium salt in an amount of from 25 to 35 mol %.

In some embodiments, the electrolyte composition is the electrolyte composition comprising:
the primary solvent is diethylether, 1,2-dimethoxyethane, 1,2-diethoxyethane, 1,3-dioxolane, 1,4-dioxane, 1,3-dioxane, or combinations thereof, wherein the primary solvent is present in an amount of from 35 to 50 mol %;
the mediating solvent is 2,2,3,3-tetrafluoro-1,4-dimethoxybutane, 1,2-bis(2,2-difluoroethoxy)ethane, 1H,1H,5H-octafluoropentyl 1,1,2,2-tetrafluoroethyl ether, 2-(2-(2,2-difluoroethoxy)ethoxy)-1,1,1-trifluoroethane, or combinations thereof, wherein the mediating solvent is present in an amount of from 5 to 20 mol %;
the diluent is 1,1,2,2-tetrafluoroethyl 2,2,3,3-tetrafluoropropyl ether, 1H,1H,5H-octafluoropentyl 1,1,2,2-tetrafluoroethyl ether, or combinations thereof, wherein the diluent is present in an amount of from 5 to 20 mol %; and
the first lithium salt is lithium bis(fluorosulfonyl)imide, lithium hexafluorophosphate, lithium 4,5-dicyano-2-(trifluoromethyl)imidazolium, lithium difluoro(oxalato)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof, wherein the first lithium salt is present in an amount of from 25 to 35 mol %.

In some embodiments, the electrolyte composition is the electrolyte composition comprising:
the primary solvent in an amount of from 35 to 50 mol %;
the mediating solvent in an amount of from 5 to 20 mol %;
the diluent in an amount of from 5 to 20 mol. %;
the first lithium salt in an amount of from 25 to 35 mol %;
the second lithium salt in an amount of from 1.5 to 2.5 mol %; and
the additive in an amount of from 0.8 to 2.5 mol %.

In some embodiments, the electrolyte composition is the electrolyte composition comprising:
the primary solvent is diethylether, 1,2-dimethoxyethane, 1,2-diethoxyethane, 1,3-dioxolane, 1,4-dioxane, 1,3-dioxane, or combinations thereof, wherein the primary solvent is present in an amount of from 35 to 50 mol %;
the mediating solvent is 2,2,3,3-tetrafluoro-1,4-dimethoxybutane, 1,2-bis(2,2-difluoroethoxy)ethane, 1H,1H,5H-octafluoropentyl 1,1,2,2-tetrafluoroethyl ether, 2-(2-(2,2-difluoroethoxy)ethoxy)-1,1,1-trifluoroethane, or combinations thereof, wherein the mediating solvent is present in an amount of from 5 to 20 mol %;
the diluent is 1,1,2,2-tetrafluoroethyl 2,2,3,3-tetrafluoropropyl ether, 1H,1H,5H-octafluoropentyl 1,1,2,2-tetrafluoroethyl ether, or combinations thereof, wherein the diluent is present in an amount of from 5 to 20 mol. %;
the first lithium salt is lithium bis(fluorosulfonyl)imide, lithium hexafluorophosphate, lithium 4,5-dicyano-2-(trifluoromethyl)imidazolium, lithium difluoro(oxalato)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof, wherein the first lithium salt is present in an amount of from 25 to 35 mol %;
the second lithium salt is lithium 4,5-dicyano-2-(trifluoromethyl)imidazolium, lithium difluoro(oxalato)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof, wherein the second lithium salt is present in an amount of from 1.5 to 2.5 mol %; and
the additive is 1,3,2-Dioxathiane 2,2-dioxide, 1,3,2-Dioxathiolane 2,2-dioxide, 2-fluoropyridine, bis(trimethylsilyl) malonate, dimethylacetamide, phenyltrifluorosilane, ethoxy(pentafluoro)triphosphazine, fluoroethylene carbonate, p-tolylsulfur pentafluoride, succinonitrile, tetrafluoroterephthalonitrile, tolylene-2,4-diisocyanate, tolylene-2,6-diisocyanate, tris(trimethylsilyl) phosphate, or combinations thereof, wherein the additive is present in an amount of from 0.8 to 2.5 mol %.

In some embodiments, the electrolyte composition is the electrolyte composition wherein:
the primary solvent comprises 1,2-dimethoxyethane;
the mediating solvent is 1H,1H,5H-octafluoropentyl 1,1,2,2-tetrafluoroethyl ether, or 2-(2-(2,2-difluoroethoxy)ethoxy)-1,1,1-trifluoroethane;
the diluent is 1,1,2,2-tetrafluoroethyl 2,2,3,3-tetrafluoropropyl ether;
the first lithium salt comprises lithium bis(fluorosulfonyl)imide (LiFSi);
the second lithium salt comprises lithium 4,5-dicyano-2-(trifluoromethyl)imidazolium, or lithium difluoro(oxalato)borate; and
the additive comprises 1,3,2-Dioxathiane 2,2-dioxide, 1,3,2-Dioxathiolane 2,2-dioxide, ethoxy(pentafluoro)triphosphazine, or tris(trimethylsilyl) phosphate.

In some embodiments, the electrolyte composition is the electrolyte composition having the composition of:
(1) 1,2-dimethoxyethane in an amount of about 47.9 mol %, 1H,1H,5H-octafluoropentyl 1,1,2,2-tetrafluoroethyl ether in an amount of about 8.3 mol %, 1,1,2,2-tetrafluoroethyl 2,2,3,3-tetrafluoropropyl ether in an amount of about 11.4 mol %, lithium bis(fluorosulfonyl)imide (LiFSi) in an amount of about 29.7 mol %, lithium difluoro(oxalato)borate in an amount of about 2.0 mol %, and ethoxy(pentafluoro)triphosphazine in an amount of about 0.7 mol %, or
(2) 1,2-dimethoxyethane in an amount of about 40.5 mol %, 2-(2-(2,2-difluoroethoxy)ethoxy)-1,1,1-trifluoroethane in an amount of about 17.6 mol %, 1,1,2,2-tetrafluoroethyl 2,2,3,3-tetrafluoropropyl ether in an amount of about 12.6 mol %, lithium bis(fluorosulfonyl)imide (LiFSi) in an amount of about 26.2 mol %, lithium 4,5-dicyano-2-(trifluoromethyl)imidazolium in an amount of about 2.3 mol %, and ethoxy(pentafluoro)triphosphazine in an amount of about 0.8 mol %.

In some embodiments, the electrolyte composition is the electrolyte composition having the composition of:
1,2-dimethoxyethane in an amount of about 47.9 mol %, 1H,1H,5H-octafluoropentyl 1,1,2,2-tetrafluoroethyl ether in an amount of about 8.3 mol %, 1,1,2,2-tetrafluoroethyl 2,2,3,3-tetrafluoropropyl ether in an amount of about 11.4 mol %,
lithium bis(fluorosulfonyl)imide in an amount of about 29.7 mol %,
lithium difluoro(oxalato)borate in an amount of about 2.0 mol %, and
ethoxy(pentafluoro)triphosphazine in an amount of about 0.7 mol %.

In some embodiments, the electrolyte composition is the electrolyte composition having the composition of:
1,2-dimethoxyethane in an amount of about 40.5 mol %,
2-(2-(2,2-difluoroethoxy)ethoxy)-1,1,1-trifluoroethane in an amount of about 17.6 mol %, 1,1,2,2-tetrafluoroethyl 2,2,3,3-tetrafluoropropyl ether in an amount of about 12.6 mol %, lithium bis(fluorosulfonyl)imide in an amount of about 26.2 mol %,
lithium 4,5-dicyano-2-(trifluoromethyl)imidazolium in an amount of about 2.3 mol %, and ethoxy(pentafluoro)triphosphazine in an amount of about 0.8 mol %.

The electrolyte composition of the present invention can have any suitable conductivity. For example, the conductivity of the electrolyte composition of the present invention can be greater than 1 mS/cm, or greater than 2, 3, 4, 5, 6, 7, 8, 9, or greater than 10 mS/cm. Representative conductivities of the electrolyte composition of the present invention include, but are not limited to, about 1 mS/cm, or about 2, 3, 4, 5, 6, 7, 8, 9, or about 10 mS/cm.

In some embodiments, the electrolyte composition is the electrolyte composition wherein the conductivity is greater than 2 mS/cm. In some embodiments, the electrolyte composition is the electrolyte composition wherein the conductivity is greater than 3 mS/cm. In some embodiments, the electrolyte composition is the electrolyte composition wherein the conductivity is greater than 5 mS/cm.

The electrolyte composition of the present invention can have any suitable dynamic viscosity. For example, the dynamic viscosity of the electrolyte composition of the present invention can be less than 10 cP, or less than 9 cP, less than 8 cP, less than 7 cP, less than 6 cP, less than 5 cP, less than 4 cP, less than 3 cP, less than 2 cP, or less than 1 cP. In some embodiments, the electrolyte composition is the electrolyte composition wherein the dynamic viscosity is less than 10 cP. In some embodiments, the electrolyte composition is the electrolyte composition wherein the dynamic viscosity is less than 5 cP.

In some embodiments, the electrolyte composition is the electrolyte composition wherein the conductivity is greater than 5 mS/cm, and the dynamic viscosity is less than 5 cP.

In some embodiments, the electrolyte compositions of the present invention do not include a carbonate solvent. In some embodiments, the electrolyte compositions of the present invention are substantially free of a carbonate solvent. Representative carbonate solvents include, but are not limited to, dimethyl carbonate, ethyl methyl carbonate, diethyl carbonate, n-propyl propionate, vinylene carbonate, ethylene carbonate, fluoroethylene carbonate, or propylene carbonate. In some embodiments, the electrolyte compositions of the present invention do not include a fluorinated carbonate solvent. In some embodiments, the electrolyte compositions of the present invention are substantially free of a fluorinated carbonate solvent. Representative fluorinated carbonate solvents include, but are not limited to, fluoroethylene carbonate, CH₃OC(O)OCH₂CF₃, CH₃OC(O)OCH₂CF₂CHF₂, CH₃OC(O)OCH₂CF₂CHF₂, CF₃CH₂OC(O)OCH₂CF₃, CH₃OC(O)OCH₂CF₂CF₂CF₃, CH₃CH₂OC(O)OCH₂CF₂CF₃, CH₃CH₂OC(O)OCH₂CF₂CHF₂, or CH₃OC(O)OCH₂CF₂CF₂CF₃. In some embodiments, the electrolyte compositions of the present invention do not include fluoroethylene carbonate. In some embodiments, the electrolyte compositions of the present invention are substantially free of fluoroethylene carbonate. When a carbonate solvent is present in the electrolyte composition of the present invention, the carbonate solvent is present in an amount of less than 5 mol %, or less than 4, 3, 2, 1, 0.5, 0.4, 0.3, 0.2, or less than 0.1 mol %.

### IV. Electrochemical Device

In some embodiments, the present invention provides an electrochemical device comprising an anode; a cathode; a separator between the anode and cathode; and an electrolyte composition of the present invention.

In some embodiments, the electrochemical device is an electrochemical cell. In some embodiments, an electrochemical cell includes a positive electrode, a negative electrode, a separator, and an electrolyte. The separator is disposed between the positive electrode and the negative electrode. The separator provides electronic isolation between the positive electrode and the negative electrode. At least a portion of the electrolyte is disposed within the separator.

Any suitable polymer can be used as the separator of the electrochemical device of the present invention. For example, the separator can include a polymer of intrinsic microporosity. Polymers of intrinsic microporosity useful in the electrochemical device of the present invention include those described in U.S. Pat. Nos. 10,710,065, and 11,394,082, U.S. Publication No. 2021/0309802, and 2019/0326578, each of which is incorporated herein by reference in its entirety.

There are two different types of PIMs, i) non-network (linear) polymers which may be soluble in organic solvents, and ii) network polymers which are generally insoluble, depending on the monomer choice. PIMs possess internal molecular free volume (IMFV), which is a measure of concavity and is defined by Swager as the difference in volume of the concave unit as compared to the non-concave shape [T M Long and T M Swager, “Minimization of Free Volume: Alignment of Triptycenes in Liquid Crystals and Stretched Polymers”, Adv. Mater, 13, 8, 601-604, 2001]. While the intrinsic microporosity in linear PIMs is claimed to derive from the impenetrable concavities given by their contorted structures, in network PIMs, microporosity is also claimed to derive from the concavities associated with macrocycles. [N B McKewon, P M Budd, “Exploitation of Intrinsic Microporosity in Polymer-Based materials”, Macromolecules, 43, 5163-5176, 2010].

The membrane layer may be in the form of a pressed powder, a collection of fibers, a compressed pellet, a film cast, sprayed or coated from solution (e.g., onto the membrane support), a composite comprised of a plurality of individual membrane layers, a free-standing film, or a supported film (e.g., by a membrane support).

In some embodiments, the membrane layer has a thickness of between about 5 nanometers and 20 micrometers, or between about 100 nanometers and 10 micrometers, or more specifically between about 500 nanometers and 5 micrometers.

In some embodiments, the separator includes a polymer of intrinsic microporosity. In some embodiments, the separator includes a polymer of intrinsic microporosity of the following formula:

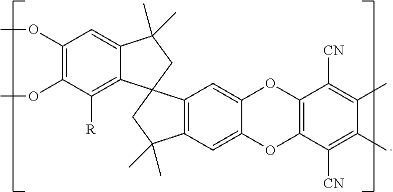

wherein each R is independently H or C₁₋₆ alkylene-NR^{a}R^{b}, each R^{a} and R^{b} is independently C₁₋₆ alkyl, C₂₋₆ alkenyl, C₂₋₆ alkynyl, or C₃₋₈ cycloalkyl, alternatively R^{a} and R^{b} are combined with the nitrogen atom to which they are attached to form a 4 to 8 membered heterocycloalkyl having 0 to 2 additional heteroatoms each independently N, O, or S.

In some embodiments, the separator includes a polymer of intrinsic microporosity. In some embodiments, the separator comprises PIM-1:

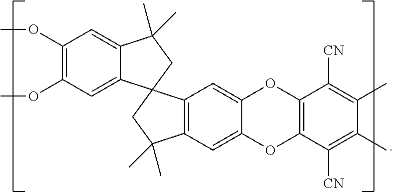

In some embodiments, the separator includes a polymer of intrinsic microporosity. In some embodiments, the separator comprises PIM-13:

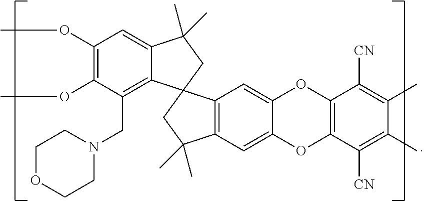

In some embodiments, the separator includes a first membrane layer. The first membrane layer may be a standalone layer, supported by a membrane support, or supported by one of the electrodes.

In some embodiments, the separator also includes a membrane support laminated to the first membrane layer. The membrane support is permeable to the electrolyte solvent. The membrane support may be a porous polymer of polypropylene, polyethylene, polyacrylonitrile, cellulose, or combinations thereof. The average pore diameter of the membrane support is at least about 10 nanometers. The first membrane layer may be disposed between the membrane support and the negative electrode.

In some embodiments, the separator also includes a second membrane layer laminated to the membrane support. The membrane support may be disposed between the first membrane layer and the second membrane layer. The first membrane layer may be permeable to the first species providing ionic communication between the positive electrode and the negative electrode, and wherein the first membrane layer is substantially impermeable to liquid electrolyte. In some embodiments, the second membrane layer includes a ceramic material selected from the group consisting of aluminum oxide, silicon oxide, silicon carbide, titanium dioxide, magnesium oxide, tin oxide, cerium oxide, zirconium oxide, barium titanate, yttrium oxide, boron nitride, and an ion conducting ceramic.

In some embodiments, the first membrane layer directly interfaces the negative electrode and the positive electrode.

In some embodiments, the electrochemical device is a lithium-ion battery with a carbon-based, metallic, or metalloid anode and a metal oxide or conversion cathode.

### V. Examples

### General

Components used in the ternary electrolyte compositions exemplified below are listed in Table 1.

TABLE 1
Components of the ternary electrolyte compositions

| Component¹ | Name | Structure |
|---|---|---|
| P-a | 1,2-dimethoxyethane | 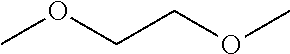 |
| P-b | 1,2-diethoxyethane | 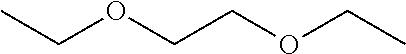 |
| | diethylether | 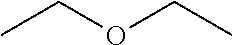 |
| | 1,3-dioxolane | 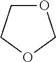 |
| | 1,4-dioxane | 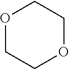 |
| | 1,3-dioxane | 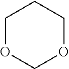 |
| M-a | 2,2,3,3-tetrafluoro-1,4- dimethoxybutane | 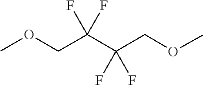 |
| M-b | 1,2-bis(2,2-difluoroethoxy)ethane | 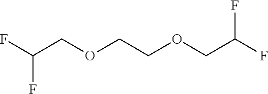 [SMILES: FC(F)COCCOCC(F)F] |
| M-c | 2-(2-(2,2-difluoroethoxy)ethoxy)- 1,1,1-trifluoroethane | 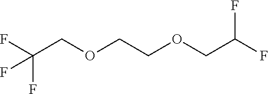 [SMILES: FC(F)COCCOCC(F)(F)F] |
| M-d/D-a | 1H,1H,5H-octafluoropentyl 1,1,2,2-tetrafluoroethyl ether (OFE) | 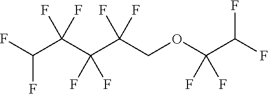 [SMILES: FC(F)C(F)(F)OCC(F)(F)C(F)(F)C(F)(F)C(F)F] |
| D-b | 1,1,2,2-tetrafluoroethyl 2,2,3,3- tetrafluoropropyl ether | 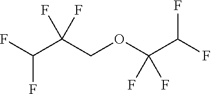 [SMILES: FC(F)C(F)(F)COC(F)(F)C(F)F] |
| A-a | 1,3,2-Dioxathiane 2,2-dioxide | 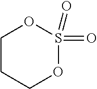 |
| A-b | 1,3,2-Dioxathiolane 2,2-dioxide | 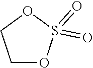 |
| A-c | 2-fluoropyridine | 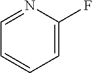 |
| A-d | bis(trimethylsilyl)malonate | 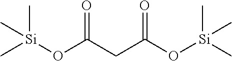 |
| A-e | dimethylacetamide | 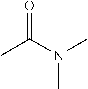 |
| A-f | phenyltrifluorosilane | 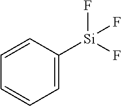 |
| A-g | ethoxy(pentafluoro)triphosphazine | 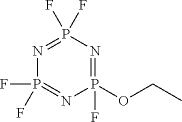 |
| A-h | fluoroethylene carbonate | 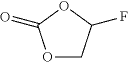 |
| A-i | p-tolylsulfur pentafluoride | 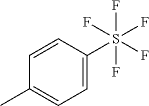 |
| A-j | succinonitrile | 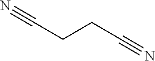 |
| A-k | tetrafluoroterephthalonitrile | 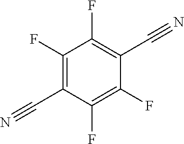 [SMILES: N#Cc1c(F)c(F)c(C#N)c(F)c1F] |
| A-l | tolylene-2,4-diisocyanate | 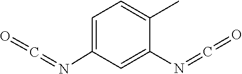 |
| A-m | tolylene-2,6-diisocyanate | 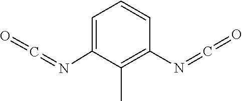 |
| A-n | tris(trimethylsilyl)phosphate | 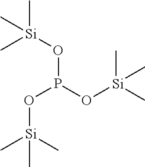 |
| A-o | nitromethane | H₃C—NO₂ |
| A-p | hexafluorotriphosphazine | 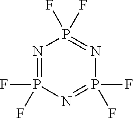 [SMILES: FP1(F)=NP(F)(F)=NP(F)(F)=N1] |
| LiFSI | lithium bis(fluorosulfonyl)imide | 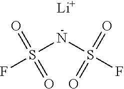 |
| LiPF₆ | lithium hexafluorophosphate | 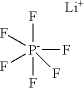 |
| Li-a | 4,5-dicyano-2- (trifluoromethyl)imidazolium | 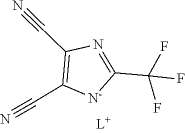 [SMILES: N#Cc1nc(C(F)(F)F)[n-]c1C#N] |
| Li-b | lithium difluoro(oxalato)borate | 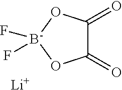 |
| Li-c | lithium bis(trifluoromethanesulfonyl)imide | 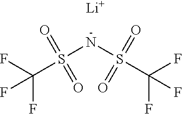 [SMILES: [Li+] ; O=S(=O)(NS(=O)(=O)C(F)(F)F)C(F)(F)F] |
| Li-d | lithium difluorophosphate | 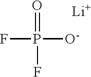 |
| Li-e | lithium nitrate | 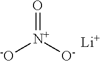 |
| Li-f | lithium perchlorate | 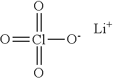 |
| Li-g | lithium tetrafluoroborate | 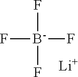 |
| Li-h | lithium trifluoromethanesulfonate | 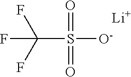 |

¹P - primary solvent; M - mediating solvent; D = diluent; A = additive; Li - lithium salt.

HOMO and LUMO energies for additives were determined by density functional theory (DFT) at the B3LYP-D3/6-31g** level of theory with Schrödinger Release 2022-3: Jaguar, Schrödinger, LLC, New York, NY, 2021 in an implicit CMSO solvent environment. Simulated structures were geometry optimized and the HOMO and LUMO were determined via a single-point energy calculation. Oxidation potentials (in V vs Li/Li+) were determined as a function of HOMO energy (eV) according to the following equation:

Oxidation Potential (V)=HOMO(eV)*(−1.01906)−1.29162

HOMO and LUMO energies as determined in DFT calculations are represented for neat molecules in an implicit DMSO solvent environment. In a real electrolyte system, coordination via dipole interaction to solvents and electrolyte salts will affect the HOMO and LUMO energies, and therefore the oxidative and reductive reactivities (respectively). The magnitude and direction of this frontier molecular orbital effect will vary depending on the site of coordination (an area of HOMO or LUMO orbital density), the concentration of the electrolyte, and the strength of the dipole interaction.

A discussion of the application of theory to the screening of electrolyte additives for lithium ion battery applications is provided here: Jankowski P, Wieczorek W, Johansson P. SEI-forming electrolyte additives for lithium-ion batteries: development and benchmarking of computational approaches. J Mol Model. 2017. A further review on electrolyte engineering employing DFT for the categorization of additive mechanistic functions is provided: He, W. Research, 2022, 1-52.

TABLE 2
Density Functional Theory of Additive Components

| | | | | Oxidation |
|---|---|---|---|---|
| Com- | | HOMO | LUMO | Potential |
| ponent | Name | eV | eV | (V, ca.) |
| A-a | 1,3,2-Dioxathiane 2,2-dioxide | −8.57 | 0.73 | 8.57 |
| A-b | 1,3,2-Dioxathiolane 2,2- | −8.52 | 0.21 | 7.39 |
| | dioxide | | | |
| A-c | 2-fluoropyridine | −7.10 | −0.90 | 5.94 |
| A-d | bis(trimethylsilyl) malonate | −7.35 | −0.30 | 6.20 |
| A-e | dimethylacetamide | −6.47 | 0.81 | 5.30 |
| A-f | phenyltrifluorosilane | −7.16 | −0.93 | 6.00 |
| A-g | ethoxy(pentafluoro)tri- | −8.36 | 0.51 | 7.23 |
| | phosphazine | | | |
| A-h | fluoroethylene carbonate | −8.70 | 0.42 | 7.57 |
| A-i | p-tolylsulfur pentafluoride | −7.15 | −1.67 | 5.99 |
| A-j | succinonitrile | −9.10 | 0.15 | 7.98 |
| A-k | tetrafluoroterephthalonitrile | −7.54 | −2.85 | 6.40 |
| A-l | tolylene-2,4-diisocyanate | −6.27 | −0.76 | 5.10 |
| A-m | tolylene-2,6-diisocyanate | −6.40 | −0.91 | 5.23 |
| A-n | tris(trimethylsilyl) phosphate | −7.67 | 1.20 | 6.52 |
| A-o | nitromethane | −8.14 | −1.99 | 7.00 |
| A-p | hexafluorotriphosphazine | −8.78 | 0.24 | — |

### Example 1: Preparation of Ternary Blend Electrolytes Wherein the Mediating Solvent is 1H,1H,5H-octafluoropentyl 1,1,2,2-tetrafluoroethyl ether

Into a dry flask under a dry atmosphere is added 6.619 g of 1,2-dimethoxyethane and 8.506 g of lithium bis(fluorosulfonyl)imide. The solution is stirred until the lithium salt is fully dissolved. Into the same flask, 0.438 g of lithium difluoro(oxalato)borate is added and dissolved fully with stirring. Once the solution is homogeneous, 4.210 g of 1H,1H,5H-octafluoropentyl 1,1,2,2-tetrafluoroethyl ether is added. Once the solution is again homogeneous, 4.051 g of 1,1,2,2-tetrafluoroethyl 2,2,3,3-tetrafluoropropyl ether is added. Finally, 0.303 g of ethoxy(pentafluoro)triphosphazine is added and the clear solution is stirred for 15 minutes. The density of the electrolyte solution is 1.40 g/mL. The conductivity is 3.52 mS/cm. The dynamic viscosity is 8.77 cP.

TABLE 3
Ternary blend electrolytes wherein the mediating solvent is 1H,1H,5H-
octafluoropentyl 1,1,2,2-tetrafluoroethyl ether (M-d)

| | | | | | | Additive | | Lithium |
|---|---|---|---|---|---|---|---|---|
| | P-a | M-d | D-b | LiFSI | | Conc. | Lithium | co-salt |
| Example | (mol %) | (mol %) | (mol %) | (mol %) | Additive | (mol %) | co-salt | (mol %) |
| 1-1 | 53.0 | 5.9 | 11.5 | 26.9 | A-g | 0.8 | Li-b | 1.9 |
| 1-2 | 44.9 | 14.8 | 10.1 | 27.1 | A-g | 0.8 | Li-b | 2.3 |
| 1-3 | 46.3 | 10.9 | 13.3 | 26.5 | A-g | 0.8 | Li-b | 2.2 |
| 1-4 | 47.9 | 8.3 | 11.4 | 29.7 | A-g | 0.7 | Li-b | 2.0 |
| 1-5 | 46.8 | 8.9 | 12.2 | 28.4 | A-b | 1.7 | Li-e | 2.0 |
| 1-6 | 47.4 | 7.8 | 11.8 | 29.4 | A-a | 1.6 | Li-b | 2.0 |
| 1-7 | 47.3 | 8.1 | 11.7 | 29.3 | A-a | 1.6 | Li-e | 2.0 |
| 1-8 | 47.9 | 7.9 | 11.9 | 29.7 | A-n | 0.7 | Li-b | 2.0 |
| 1-9 | 49.4 | 9.3 | 12.8 | 25.7 | A-n | 0.7 | Li-e | 2.1 |
| 1-10 | 50.4 | 9.4 | 13.0 | 26.4 | A-g | 0.8 | None | NA |
| 1-11 | 47.7 | 8.2 | 11.4 | 29.6 | A-1 | 1.11 | Li-b | 2.0 |
| 1-12 | 47.0 | 8.1 | 11.2 | 29.8 | A-g/A-1 | 0.7/1.18 | Li-b | 2.0 |
| 1-13 | 46.7 | 8.0 | 11.1 | 29.0 | A-o | 3.24 | Li-b | 2.0 |
| 1-14 | 48.1 | 7.7 | 10.6 | 29.6 | A-p | 1.99 | Li-b | 2.0 |
| 1-15 | 48.3 | 7.8 | 11.1 | 30.0 | A-p | 0.82 | Li-b | 2.0 |
| 1-16 | 48.4 | 8.4 | 11.6 | 30.0 | A-g | 0.73 | Li-b | 1.0 |

### Example 2: Preparation of Ternary Blend Electrolytes where the Mediating Solvent is 2-(2-(2,2-difluoroethoxy)ethoxy)-1,1,1-trifluoroethane (M-c)

Into a dry flask under a dry atmosphere is added 1.750 g of 1,2-dimethoxyethane and 2.347 g of lithium bis(fluorosulfonyl)imide. The solution is stirred until the lithium salt is fully dissolved. Into the same flask, 0.156 g of lithium difluoro(oxalato)borate is added and dissolved fully with stirring. Once the solution is homogeneous, 1.752 g of 2-(2-(2,2-difluoroethoxy)ethoxy)-1,1,1-trifluoroethane is added. Once the solution is again homogeneous, 1.403 g of 1,1,2,2-tetrafluoroethyl 2,2,3,3-tetrafluoropropyl ether is added. Finally, 0.107 g of ethoxy(pentafluoro)triphosphazine is added and the clear solution is stirred for 15 minutes. The density of the electrolyte solution is 1.38 g/mL. The conductivity is 4.34 mS/cm. The dynamic viscosity is 6.68 cP.

TABLE 4
Ternary blend electrolytes where the mediating solvent is
2-(2-(2,2-difluoroethoxy)ethoxy)-1,1,1-trifluoroethane

| | | | | | | Additive | | Lithium |
|---|---|---|---|---|---|---|---|---|
| | P-a | M-c | D-b | LiFSI | | Conc. | Lithium | co-salt |
| Example | (mol %) | (mol %) | (mol %) | (mol %) | Additive | (mol %) | co-salt | (mol %) |
| 2-1 | 40.5 | 17.6 | 12.6 | 26.2 | A-g | 0.8 | Li-a | 2.3 |
| 2-2 | 52.7 | 9.1 | 11.5 | 23.3 | A-g | 1.5 | Li-a | 1.9 |
| 2-3 | 48.2 | 9.1 | 11.3 | 28.9 | A-g | 0.7 | Li-a | 1.8 |
| 2-4 | 47.8 | 9.5 | 11.2 | 29.0 | A-n | 0.6 | Li-a | 1.9 |
| 2-5 | 47.0 | 9.3 | 10.9 | 28.8 | A-h | 2.2 | Li-a | 1.8 |

### Example 3: Preparation of Ternary Blend Electrolytes Wherein the Primary Solvent is 1,2-diethoxyethane

Into a dry flask under a dry atmosphere is added 6.605 g of 1,2-diethoxyethane and 7.241 g of lithium bis(fluorosulfonyl)imide. The solution is stirred until the lithium salt is fully dissolved. Into the same flask, 0.216 g of lithium difluoro(oxalato)borate is added and dissolved fully with stirring. Once the solution is homogeneous, 4.065 g of 1H, 1H,5H-octafluoropentyl-2,2-tetrafluoroethyl ether is added. Once the solution is again homogeneous, 4.058 g of 1,1,2,2-tetrafluoroethyl 2,2,3,3-tetrafluoropropyl ether is added. Finally, 0.305 g of ethoxy(pentafluoro)triphosphazine is added and the clear solution is stirred for 15 minutes. The density of the electrolyte solution is 1.37 g/mL. The conductivity is 2.52 mS/cm. The dynamic viscosity is 19.80 CP.

| | | | | | | Additive | | Lithium |
|---|---|---|---|---|---|---|---|---|
| | P-b | M-d | D-b | LiFSI | | Conc. | Lithium | co-salt |
| Example | (mol %) | (mol %) | (mol %) | (mol %) | Additive | (mol %) | co-salt | (mol %) |
| 3-1 | 46.16 | 7.90 | 11.28 | 32.72 | A-g | 0.85 | Li-b | 1.09 |
| 3-2 | 47.85 | 6.92 | 9.95 | 33.45 | A-g | 0.77 | Li-b | 1.06 |
| 3-3 | 44.07 | 9.64 | 13.76 | 30.48 | A-g | 0.87 | Li-b | 1.18 |
| 3-4 | 47.20 | 8.12 | 11.58 | 31.17 | A-g | 0.83 | Li-b | 1.11 |
| 3-5 | 48.91 | 6.73 | 9.82 | 32.05 | A-g | 0.77 | Li-b | 1.07 |
| 3-6 | 48.86 | 7.11 | 10.13 | 32.07 | A-g | 0.79 | Li-b | 1.07 |

### Example 4: Cycle Life

Lithium metal battery cells containing exemplified electrolytes were constructed by first generating a device stack containing a 3 cm×4 cm active area (12 cm²) lithium or lithium alloy anode (20 μm lithium on a 10 μm copper foil current collector), a separator (16 um polyethylene), and a cathode (3.8 mAh/cm² NMC-811), contained within a laminate pouch sealed on three sides. Exemplified electrolytes (2.0 g/Ah) were then added to these pouch cells and the remaining open side of the battery pouch cell was vacuum sealed. The lithium metal battery cells were then placed in a pressure fixturing at 100 PSI and allowed to equilibrate for a 12-48 hour rest period. The cycle life is determined after cycling according to cycle life protocol P1 or P2, and is equivalent to the number of cycles the cell is charged and discharged until the cell reaches 80% of its initial capacity referenced to cycle 2.

Cycle Life P1: Lithium metal battery cells are cycled at a charge rate of 1C (current density of 3.8 mA/cm²) and discharge rate of C/2 (discharge current density of 1.9 mA/cm²). At the first cycle and every 25 cycles thereafter, a rate-performance test is specified in the cycling protocol, wherein a slow C/10 charge is completed. At the second cycle and every 50 cycles thereafter, a hybrid-pulse power (HPPC) experiment is specified in the cycling protocol. The HPPC cycles are not counted toward the total cycle life.

Cycle Life P2: Lithium metal battery cells are cycled at a charge rate of C/3 (current density of 1.27 mA/cm²) and discharge rate of C/3 (discharge current density of 1.27 mA/cm²).

Cycle Life P3: Lithium metal battery cells are cycled at a charge rate of C/5 (current density of 0.76 mA/cm²) and discharge rate of 1D (discharge current density of 3.8 mA/cm²).

### Example 5: Cycle Life of Electrolytes with a PIM-13 Coated Separator

Lithium metal battery cells containing exemplified electrolytes were constructed by first generating a device stack containing a 3 cm×4 cm active area (12 cm²) lithium or lithium alloy anode (20 μm lithium on a 10 μm copper foil current collector), a PIM-13 coated separator, and a cathode (3.8 mAh/cm² NMC-811), contained within a laminate pouch sealed on three sides. The PIM-13 coated separator comprises a 16 μm PE separator substrate with a single side coating of PIM-13 (1.03 g/m² gravimetric mass loading) interfacing the lithium metal anode. The Exemplified electrolytes (2.0 g/Ah) were then added to these pouch cells and the remaining open side of the battery pouch cell was vacuum sealed. The lithium metal battery cells were then placed in a pressure fixturing at 100 PSI and allowed to equilibrate for a 48 hour rest period. The cycle life is determined after cycling according to cycle life protocol P2, and is equivalent to the number of cycles the cell is charged and discharged until the cell reaches 80% of its initial capacity referenced to cycle 2.

TABLE 5
Cycle Life

| | Cycle | Cycle | Cycle life (PIM-13 | Cycle |
|---|---|---|---|---|
| Example | Life - P1 | life - P2 | separator) P2 | Life - P3 |
| 1-1 | 86 | 90 | | 206 |
| 1-2 | 103 | 135 | | |
| 1-3 | 101 | 128 | | 225 |
| 1-4a | 114 | 142 | 150 | |
| 1-4b | 126 | 161 | 156 | 240 |
| 1-5 | 103 | | | |
| 1-6 | 107 | | | |
| 1-7 | 103 | 138 | | |
| 1-8 | 106 | | | |
| 1-9 | 103 | | | |
| 1-10 | 103 | | | |
| 1-11 | 133 | | 152 | |
| 1-12 | 137 | | 158 | |
| 1-13 | 131 | 141 | 142 | |
| 1-14 | 129 | | | |
| 1-15 | 132 | | | |
| 1-16 | 128 | | 154 | |
| 2-1 | 100 | 139 | 147 | 260 |
| 2-2 | 74 | 105 | | 225 |
| 3-1 | 142 | | | |
| 3-2 | 136 | | | |
| 3-3 | 134 | 193 | 166 | 248 |
| 3-4 | 130 | | | |
| 3-5 | 130 | | | |
| 3-6 | 129 | | | |
| E4 | 53 | 86 | 89 | 89 |
| E5 | 69 | 116 | | |
| E6 | 58 | | | |

### Example 6: Simulated Li+ Coordination Energies

Density functional theory was used to simulate the lithium coordination energy of example primary solvent, mediating solvent, and diluent compounds. Molecules were built and minimized using an OPLS_2005 force field, then geometry optimized using DFT at the B3LYP-d3/6-31g** level of theory in an implicit DMSO solvent environment. The final energy of the optimized E[Li+]—[solvent compound] complex was subtracted by the sum of the final energy of an uncoordinated Li+ ion and that of the corresponding solvent compound according to the equation below. A more negative Li+ coordination energy implies a stronger Li+ coordination complex is formed between the solvent compound and the lithium ion.

Li+ coordination energy=E[Li+]—[solvent compound]−(E[Li+]+E[solvent compound])

TABLE 6
DFT coordination energies of selected primary
solvents, mediating solvents, and diluents

| | | Li+ coordination |
|---|---|---|
| Component | Name | Energy |
| P-a | 1,2-dimethoxyethane | −43.65 |
| P-b | 1,2-diethoxyethane | −45.00 |
| M-a | 2,2,3,3-tetrafluoro-1,4- | −36.93 |
| | dimethoxybutane | |
| M-c | 2-(2-(2,2-difluoroethoxy)ethoxy)- | −54.27 |
| | 1,1,1-trifluoroethane | |
| M-d/D-a | 1H,1H,5H-octafluoropentyl 1,1,2,2- | −31.25 |
| | tetrafluoroethyl ether | |
| D-b | 1,1,2,2-tetrafluoroethyl 2,2,3,3- | −33.62 |
| | tetrafluoropropyl ether | |

### Example 7: Solvation Cluster Analysis in Simulated Bulk Electrolytes

Molecular dynamics (Schrōdinger Release 2022-3: Desmond Molecular Dynamics System, D. E. Shaw Research, New York, NY, 2021. Maestro-Desmond Interoperability Tools, Schrōdinger, New York, NY, 2021) was used to simulate the lithium solvation environment for Electrolyte 2-1). A disordered system comprising 100 total molecules was generated according to the molar ratio specified in Example 2-1, then an NPT (1 atm, 300K) molecular dynamics simulation was run for a duration of 500 ns. The average coordination environment (% basis) as a function of distance from each Li+ ion was determined using a radial distribution function analysis. The resulting average Li+ coordination environment as a function of distance from central Li+ ion is summarized in Table 7.

TABLE 7
Molecular Dynamics simulated coordination environment
as a function of distance from Li+ in Electrolyte 2-1.

| Distance | P-a | M-c | D-b | A-n | FSI | DFOB |
|---|---|---|---|---|---|---|
| 2.5 Å | 13.97 | 1.3 | 0.00 | 1.44 | 79.38 | 3.9 |
| 3.3 Å | 19.25 | 3.04 | 0.23 | 1.60 | 71.85 | 4.04 |
| 4.5 Å | 28.43 | 8.12 | 2.05 | 1.78 | 55.99 | 3.63 |
| 6.0 Å | 36.94 | 10.5 | 5.45 | 1.53 | 43 | 2.59 |

### Example 8: Electrolyte (E4)

An electrolyte mixture was prepared by mixing the following components (mol %): dimethyl carbonate 48%, fluoroethylene carbonate 39%, tolylene-2,6-diisocyanate 1%, Lithium bis(fluorosulfonyl)imide 10%, Lithium difluoro(oxalato)borate 2%.

### Example 9: Electrolyte (E5)

Into a dry flask under a dry atmosphere is added 1.95 g of 1,2-dimethoxymethane and 3.929 g of lithium bis(fluorosulfonyl)imide. The solution is stirred until the lithium salt is fully dissolved. Once the solution is homogeneous, 13.050 g of 1,1,2,2-tetrafluoroethyl 2,2,3,3-tetrafluoropropyl ether is added. The clear solution is stirred for 15 minutes. The density of the electrolyte solution Electrolyte E5 is 1.50 g/mL. The conductivity is 1.52 mS/cm. The dynamic viscosity is 3.11 cP.

### Example 10: Electrolyte (E6)

Into a dry flask under a dry atmosphere is added 3.31 g of 1,2-dimethoxymethane and 3.452 g of lithium bis(fluorosulfonyl)imide. The solution is stirred until the lithium salt is fully dissolved. Once the solution is homogeneous, 11.70 g of 1,1,2,2-tetrafluoroethyl 2,2,3,3-tetrafluoropropyl ether is added. The clear solution is stirred for 15 minutes. The density of the electrolyte solution LIT009 is 1.42 g/mL. The conductivity is 5.25 mS/cm. The dynamic viscosity is 2.56 cP.

### Example 11: Electrolyte Composition Analysis by Nuclear Magnetic Resonance Spectroscopy (NMR) after Cell Cycling

A composition analysis study was run with Example Electrolyte 1-4 before and after battery cycling to check for consumption of SEI and CEI forming additive compounds. A first pristine sample of Electrolyte 1-4 was acquired immediately after mixing the sample. A second post-mortem sample of Example Electrolyte 1-4 was collected from a cell that had been cycled to 80% capacity. Both samples were analyzed by ¹H, ¹³C, ¹⁹F, ³¹P, and ¹¹B NMR spectroscopic methods. In the pristine sample of Electrolyte 1-4, all constituent components were observed (Table 8). In the post-mortem sample of Electrolyte 1-4, components A-g (observed in the pristine sample via ³¹P NMR) and Li-b (observed in the pristine sample via ¹⁹F and ¹¹B NMR) were no longer detectable by NMR, indicating their concentration in solution is below the limit of detection (Table 9). In the post-mortem sample, components LiFSI (observed through ¹⁹F NMR), P-a (Observed through ¹H and ¹³C NMR), M-d/D-a and D-b (both observed through ¹⁹F NMR) were still observed, indicating they persist in solution throughout the cell's standard operational lifetime.

TABLE 8
Pristine NMR for Electrolyte 1-4

| | ¹H-NMR | ¹³C-NMR | ¹⁹F-NMR | ³¹P-NMR | ¹¹B-NMR |
|---|---|---|---|---|---|
| | (500.0 MHz, | (125.7 MHz, | (470.5 MHz, | (202.4 MHz, | (160.4 MHz, |
| | DMSO-d6), | DMSO-d6), | DMSO-d6) | DMSO-d6) | DMSO-d6) |
| Component | δ (ppm) | δ (ppm) | δ (ppm): | δ (ppm) | δ (ppm) |
| P-a | 3.23 (s, 6H), | 58.2, 71.5 | | | |
| | 3.42 (s, 4H) | | | | |
| M-d/D-a | 4.74 (t, J = 13.6 | | −91.67 (s, 2F), | | |
| | Hz, 2H), | | −120.30 (t, J = 11.5 | | |
| | 6.47 (m, 3H), | | Hz, 2F), | | |
| | 6.87 (tt, J = 50.5 | | −125.06 (t, J = 9.0 | | |
| | Hz, J = 5.5 | | Hz, 2F), | | |
| | Hz, 1H) | | −130.23 (m, 2F), | | |
| | | | −138.37 (t, J = 5.5 | | |
| | | | Hz, 2F), | | |
| | | | −138.94 (t, J = 8.0 | | |
| | | | Hz, 2F) | | |
| D-b | 4.54 (t, J = 13.6 | | −91.77 (s, 2F), | | |
| | Hz, 2H), | | 126.07 (s, 2F), | | |
| | 6.47 (m, 3H) | | −138.26 (t, J = 5.7 | | |
| | | | Hz, 2F), | | |
| | | | −139.44 (t, J = 5.3 | | |
| | | | Hz, 2F) | | |
| LiFSI | | | 52.58 (s, 2F) | | |
| A-g | 1.32 (t, J = 7.0 | | | 6.38 (m, 1P), | |
| | Hz, 3H) | | | 11.02 (m, 1P), | |
| | | | | 15.50 (m, 1P) | |
| Li-b | | | −149.13 (s, 2F) | | 2.65 (s, 1B) |

TABLE 9
Post-Mortem NMR for Electrolyte 1-4

| | ¹H-NMR | ¹³C-NMR | ¹⁹F-NMR | ³¹P-NMR | ¹¹B-NMR |
|---|---|---|---|---|---|
| | (500.0 MHz, | (125.7 MHz, | (470.5 MHz, | (202.4 MHz, | (160.4 MHz, |
| | DMSO-d6), | DMSO-d6), | DMSO-d6) | DMSO-d6) | DMSO-d6) |
| Component | δ (ppm) | δ (ppm) | δ (ppm): | δ (ppm) | δ (ppm) |
| P-a | 3.23 (s, 6H), | 58.0, 71.1 | | | |
| | 3.42 (s, 4H) | | | | |
| M-d/D-a | 4.90 (t, J = 13.7 | | −90.82 (s, 2F), | | |
| | Hz, 2H), | | −119.76 (t, J = 11.5 | | |
| | 6.64 (m, 3H), | | Hz, 2F), | | |
| | 7.08 (tt, J = 5.01 | | −124.55 (t, J = 9.0 | | |
| | Hz, J = 5.6 | | Hz, 2F), | | |
| | Hz, 1H) | | −129.86 (m, 2F), | | |
| | | | −138.12 (t, J = 5.5 | | |
| | | | Hz, 2F), | | |
| | | | −138.72 (t, J = 8.0 | | |
| | | | Hz, 2F) | | |
| D-b | 4.66 (t, J = 13.9 | | −90.94 (s, 2F), | | |
| | Hz, 2H), | | −125.61 (s, 2F), | | |
| | 6.64 (m, 3H) | | −137.98 (t, J = 5.7 | | |
| | | | Hz, 2F), | | |
| | | | −138.99 (t, J = 5.3 | | |
| | | | Hz, 2F) | | |
| LiFSI | | | 52.96 (s, 2F) | | |
| A-g | Not observed | | | Not observed | |
| Li-b | | | Not observed | | Not observed |

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

What is claimed is:

1. An electrolyte composition comprising:
a primary solvent;
a mediating solvent;
a diluent; and
a first lithium salt,
wherein each of the primary solvent, mediating solvent, and diluent are different.

2. The electrolyte composition of claim 1, wherein the electrolyte composition does not include a carbonate solvent.

3. The electrolyte composition of claim 1 or 2, wherein the primary solvent comprises an ether, a glyme, a cyclic ether, or combinations thereof.

4. The electrolyte composition of any one of claims 1 to 3, wherein the primary solvent comprises diethylether, 1,2-dimethoxyethane, 1,2-diethoxyethane, 1,3-dioxolane, 1,4-dioxane, 1,3-dioxane, or combinations thereof.

5. The electrolyte composition of any one of claims 1 to 4, wherein the primary solvent comprises diethylether, 1,2-dimethoxyethane, 1,2-diethoxyethane, or combinations thereof.

6. The electrolyte composition of any one of claims 1 to 5, wherein the primary solvent comprises 1,2-diethoxyethane.

7. The electrolyte composition of any one of claims 1 to 5, wherein the primary solvent comprises 1,2-dimethoxyethane.

8. The electrolyte composition of any one of claims 1 to 7, wherein the primary solvent is present in the electrolyte composition in an amount of from 20 to 70 mol %.

9. The electrolyte composition of any one of claims 1 to 8, wherein the primary solvent is present in the electrolyte composition in an amount of from 35 to 50 mol %.

10. The electrolyte composition of any one of claims 1 to 9, wherein the mediating solvent comprises a fluorinated ether, a fluorinated glyme, a fluorinated cyclic ether, or combinations thereof.

11. The electrolyte composition of any one of claims 1 to 10, wherein the mediating solvent comprises 2,2,3,3-tetrafluoro-1,4-dimethoxybutane, 2-(2-ethoxyethoxy)-1,1,1-trifluoroethane, 1,2-bis(2,2-difluoroethoxy)ethane, 1,2-bis(2,2,2-trifluoroethoxy)ethane, 1H,1H,5H-octafluoropentyl 1,1,2,2-tetrafluoroethyl ether, 2-(2-(2,2-difluoroethoxy)ethoxy)-1,1,1-trifluoroethane, or combinations thereof.

12. The electrolyte composition of any one of claims 1 to 11, wherein the mediating solvent comprises 2,2,3,3-tetrafluoro-1,4-dimethoxybutane, 1,2-bis(2,2-difluoroethoxy)ethane, 1H,1H,5H-octafluoropentyl 1,1,2,2-tetrafluoroethyl ether, 2-(2-(2,2-difluoroethoxy)ethoxy)-1,1,1-trifluoroethane, or combinations thereof.

13. The electrolyte composition of any one of claims 1 to 12, wherein the mediating solvent comprises 1H,1H,5H-octafluoropentyl 1,1,2,2-tetrafluoroethyl ether, 2-(2-(2,2-difluoroethoxy)ethoxy)-1,1,1-trifluoroethane, or combinations thereof.

14. The electrolyte composition of any one of claims 1 to 13, wherein the mediating solvent comprises 1H,1H,5H-octafluoropentyl 1,1,2,2-tetrafluoroethyl ether.

15. The electrolyte composition of any one of claims 1 to 14, wherein the mediating solvent comprises 2-(2-(2,2-difluoroethoxy)ethoxy)-1,1,1-trifluoroethane.

16. The electrolyte composition of any one of claims 1 to 15, wherein the mediating solvent is present in the electrolyte composition in an amount of from 1 to 30 mol %.

17. The electrolyte composition of any one of claims 1 to 16, wherein the mediating solvent is present in the electrolyte composition in an amount of from 5 to 20 mol %.

18. The electrolyte composition of any one of claims 1 to 17, wherein the diluent comprises a fluorinated ether, a fluorinated glyme, a cyclic ether, a fluorinated cyclic ether, or combinations thereof.

19. The electrolyte composition of any one of claims 1 to 18, wherein the diluent comprises 1,1,2,2-tetrafluoroethyl 2,2,3,3-tetrafluoropropyl ether, 1H,1H,5H-octafluoropentyl 1,1,2,2-tetrafluoroethyl ether, or combinations thereof.

20. The electrolyte composition of any one of claims 1 to 19, wherein the diluent comprises 1,1,2,2-tetrafluoroethyl 2,2,3,3-tetrafluoropropyl ether, 1H,1H,5H-octafluoropentyl 1,1,2,2-tetrafluoroethyl ether, or combinations thereof.

21. The electrolyte composition of any one of claims 1 to 20, wherein the diluent comprises 1,1,2,2-tetrafluoroethyl 2,2,3,3-tetrafluoropropyl ether.

22. The electrolyte composition of any one of claims 1 to 21, wherein the diluent is present in the electrolyte composition in an amount of from 1 to 30 mol %.

23. The electrolyte composition of any one of claims 1 to 22, wherein the diluent is present in the electrolyte composition in an amount of from 5 to 20 mol %.

24. The electrolyte composition of any one of claims 1 to 23, wherein the first lithium salt comprises lithium bis(fluorosulfonyl)imide (LiFSi), or lithium hexafluorophosphate, or combinations thereof.

25. The electrolyte composition of any one of claims 1 to 24, wherein the first lithium salt comprises lithium bis(fluorosulfonyl)imide (LiFSi).

26. The electrolyte composition of any one of claims 1 to 25, wherein the first lithium salt is present in the electrolyte composition in an amount of from 10 to 50 mol %.

27. The electrolyte composition of any one of claims 1 to 26, wherein the first lithium salt is present in the electrolyte composition in an amount of from 25 to 35 mol %.

28. The electrolyte composition of any one of claims 1 to 27, wherein the molar ratio of the primary solvent to the first lithium salt is from 3.5:1 to 1.4:1.

29. The electrolyte composition of any one of claims 1 to 28, wherein the molar ratio of the primary solvent to the first lithium salt is from 2.0:1 to 1.4:1.

30. The electrolyte of any one of claims 1 to 29, further comprising a second lithium salt that is different from the first lithium salt.

31. The electrolyte composition of claim 30, wherein the second lithium salt comprises lithium 4,5-dicyano-2-(trifluoromethyl)imidazolium, lithium difluoro(oxalato)borate, lithium bis(trifluoromethanesulfonyl)imide, lithium difluorophosphate, lithium nitrate, lithium perchlorate, lithium tetrafluoroborate, lithium trifluoromethanesulfonate, or combinations thereof.

32. The electrolyte composition of claim 30 or 31, wherein the second lithium salt comprises lithium 4,5-dicyano-2-(trifluoromethyl)imidazolium, lithium difluoro(oxalato)borate, or combinations thereof.

33. The electrolyte composition of any one of claims 30 to 32, wherein the second lithium salt comprises lithium 4,5-dicyano-2-(trifluoromethyl)imidazolium.

34. The electrolyte composition of any one of claims 30 to 32, wherein the second lithium salt comprises lithium difluoro(oxalato)borate.

35. The electrolyte composition of any one of claims 30 to 32, wherein the second lithium salt comprises lithium nitrate.

36. The electrolyte composition of any one of claims 30 to 35, wherein the second lithium salt is present in the electrolyte composition in an amount of from 0.1 to 5 mol %.

37. The electrolyte composition of any one of claims 30 to 36, wherein the second lithium salt is present in the electrolyte composition in an amount of 1 to 3 mol %.

38. The electrolyte composition of any one of claims 1 to 37, further comprising an additive.

39. The electrolyte composition of any one of claims 1 to 38, wherein the additive comprises 1,3,2-Dioxathiane 2,2-dioxide, 1,3,2-Dioxathiolane 2,2-dioxide, 2-fluoropyridine, bis(trimethylsilyl) malonate, dimethylacetamide, phenyltrifluorosilane, ethoxy(pentafluoro)triphosphazine, fluoroethylene carbonate, p-tolylsulfur pentafluoride, succinonitrile, tetrafluoroterephthalonitrile, tolylene-2,4-diisocyanate, tolylene-2,6-diisocyanate, tris(trimethylsilyl) phosphate, or combinations thereof.

40. The electrolyte composition of any one of claims 1 to 39, wherein the additive comprises 1,3,2-Dioxathiane 2,2-dioxide.

41. The electrolyte composition of any one of claims 1 to 39, wherein the additive comprises 1,3,2-Dioxathiolane 2,2-dioxide.

42. The electrolyte composition of any one of claims 1 to 39, wherein the additive comprises ethoxy(pentafluoro)triphosphazine.

43. The electrolyte composition of any one of claims 1 to 39, wherein the additive comprises tris(trimethylsilyl) phosphate, or combinations thereof.

44. The electrolyte composition of any one of claims 1 to 43, wherein the additive is present in the electrolyte composition in an amount of from 0.1 to 5 mol %.

45. The electrolyte composition of any one of claims 1 to 44, wherein the additive is present in the electrolyte composition in an amount of from 0.8 to 2.5 mol %.

46. The electrolyte composition of any one of claims 1 to 45, wherein:
the primary solvent comprises 1,2-dimethoxyethane;
the mediating solvent is 1H,1H,5H-octafluoropentyl 1,1,2,2-tetrafluoroethyl ether, or 2-(2-(2,2-difluoroethoxy)ethoxy)-1,1,1-trifluoroethane;
the diluent is 1,1,2,2-tetrafluoroethyl 2,2,3,3-tetrafluoropropyl ether;
the first lithium salt comprises lithium bis(fluorosulfonyl)imide (LiFSi);
the second lithium salt comprises lithium 4,5-dicyano-2-(trifluoromethyl)imidazolium, or lithium difluoro(oxalato)borate; and
the additive comprises 1,3,2-Dioxathiane 2,2-dioxide, 1,3,2-Dioxathiolane 2,2-dioxide, ethoxy(pentafluoro)triphosphazine, or tris(trimethylsilyl) phosphate.

47. The electrolyte composition of any one of claims 1 to 46, having the composition of:
(1) 1,2-dimethoxyethane in an amount of about 47.9 mol %, 1H,1H,5H-octafluoropentyl 1,1,2,2-tetrafluoroethyl ether in an amount of about 8.3 mol %,
1,1,2,2-tetrafluoroethyl 2,2,3,3-tetrafluoropropyl ether in an amount of about 11.4 mol %,
lithium bis(fluorosulfonyl)imide (LiFSi) in an amount of about 29.7 mol %, lithium difluoro(oxalato)borate in an amount of about 2.0 mol %, and
ethoxy(pentafluoro)triphosphazine in an amount of about 0.7 mol %, or
(2) 1,2-dimethoxyethane in an amount of about 40.5 mol %, 2-(2-(2,2-difluoroethoxy)ethoxy)-1,1,1-trifluoroethane in an amount of about 17.6 mol %,
1,1,2,2-tetrafluoroethyl 2,2,3,3-tetrafluoropropyl ether in an amount of about 12.6 mol %,
lithium bis(fluorosulfonyl)imide (LiFSi) in an amount of about 26.2 mol %, lithium 4,5-dicyano-2-(trifluoromethyl)imidazolium in an amount of about 2.3 mol %, and
ethoxy(pentafluoro)triphosphazine in an amount of about 0.8 mol %.

48. The electrolyte composition of any one of claims 1 to 47, wherein the conductivity is greater than 2 mS/cm.

49. The electrolyte composition of any one of claims 1 to 48, wherein the dynamic viscosity is less than 10 cP.

50. An electrochemical device comprising
an anode;
a cathode;
a separator between the anode and cathode; and
an electrolyte composition according to any one of claims 1 to 49.

51. The electrochemical device of claim 50, wherein the separator comprises a polymer of intrinsic microporosity.
